(19) United States
(12) Patent Application Publication
(10) Pub. No.: US 2025/0269278 A1
(43) Pub. Date: Aug. 28, 2025

(54) NON-TRANSITORY COMPUTER READABLE MEDIUM STORING PROGRAM AND GAME APPARATUS

(71) Applicant: BANDAI CO., LTD., Tokyo (JP)

(72) Inventors: Satoshi TAKEDA, Tokyo (JP); Masahiko SAITO, Tokyo (JP); Kensuke MITA, Tokyo (JP)

(21) Appl. No.: 19/062,350

(22) Filed: Feb. 25, 2025

(30) Foreign Application Priority Data
Feb. 28, 2024 (JP) 2024-029209

(51) Int. Cl. A63F 13/52

(52) U.S. Cl. CPC A63F 13/52

(57) ABSTRACT

A non-transitory computer readable medium stores a program causing a computer to execute a display control process for controlling a display device to display a game screen containing a field, the computer executing an electronic game that progresses by placing game elements on the field. The display control process includes placing and displaying, among game elements associated with a player, a game element of a first type and a game element of a second type in visually different forms on the field, the game element of the first type and the game element of the second type having different roles in progression of the electronic game.

### CROSS-REFERENCE TO RELATED APPLICATIONS

This application claims priority to Japanese Patent Application No. 2024-029209 filed in the Japan Patent Office on Feb. 28, 2024, the entire contents of which are incorporated herein by reference.

### BACKGROUND OF THE INVENTION

### 1. Field of the Invention

The present invention relates to a non-transitory computer readable medium storing a program and a game apparatus and more specifically to an electronic game based on the theme of a trading card game.

### 2. Description of the Related Art

There is an electronic game based on the theme of a trading card game (TCG) that enables online competition among users (Japanese Unexamined patent Application Publication No. 2021-037078).

### SUMMARY OF THE INVENTION

As in Japanese Unexamined patent Application Publication No. 2021-037078, the mode in which two-dimensional images of cards associated with each player are placed on a field provides play experiences similar to those of TCGs that physically use cards and a field in the real world; however, the entertainment values of competitive games may be reduced.

An object of the present invention is to provide a non-transitory computer readable medium storing a program and a game apparatus that provide highly entertaining play experiences.

An aspect of the present invention is a non-transitory computer readable medium storing a program causing a computer to execute a display control process for controlling a display device to display a game screen containing a field, the computer executing an electronic game that progresses by placing game elements on the field, the display control process including: placing and displaying, among game elements associated with a player, a game element of a first type and a game element of a second type in visually different forms on the field, the game element of the first type and the game element of the second type having different roles in progression of the electronic game.

The present invention makes it possible to provide highly entertaining play experiences.

### BRIEF DESCRIPTION OF THE DRAWINGS

FIG. 1 is a diagram illustrating an example of the configuration of a game system according to embodiments and modifications of the present invention;

FIG. 2 is a block diagram illustrating an example of a hardware configuration of a player terminal according to the embodiments and modifications of the present invention;

FIG. 3 is a block diagram illustrating an example of a hardware configuration of a server according to the embodiments and modifications of the present invention;

FIG. 4 is a diagram illustrating an example of a game screen of a competitive game according to the embodiments and modifications of the present invention;

FIG. 5 is a diagram for describing the configuration of a battle area in the competitive game according to the embodiments and modifications of the present invention;

FIG. 6 is a diagram illustrating an example of display related to an attack action in the competitive game according to the embodiments and modifications of the present invention;

FIGS. 7A to 7C are other diagrams illustrating an example of display related to an attack action in the competitive game according to the embodiments and modifications of the present invention;

FIGS. 8A to 8B are diagrams illustrating an example of display related to a combo operation in the competitive game according to the embodiments and modifications of the present invention;

FIGS. 9A to 9C are diagrams illustrating an example of activation presentation of an attack action in the competitive game according to the embodiments and modifications of the present invention;

FIGS. 10A to 10C are diagrams for describing changes in the display form of a field in the competitive game according to the embodiments and modifications of the present invention;

FIG. 11 is a flowchart illustrating an example of a competitive game process executed by the player terminal according to the embodiments and modifications of the present invention;

FIG. 12 is a flowchart illustrating an example of an operation phase process executed by the player terminal according to the embodiments and modifications of the present invention; and

FIG. 13 is a flowchart illustrating an example of a defense action process executed by the player terminal according to the embodiments and modifications of the present invention.

### DESCRIPTION OF THE PREFERRED EMBODIMENTS

### Embodiments

In the following, embodiments will be described in detail with reference to the attached drawings. Note that the following embodiments are not intended to limit the invention according to the claims, and not all of the combinations of features described in the embodiments are essential to the invention. Two or more features among the multiple features described in the embodiments may be freely combined. The same reference numerals are used for identical or similar configurations, and redundant description will be omitted.

An embodiment described below is an example of a game system to which the present invention is applied, the game system providing a service (competitive service) through which a server establishing communication connection to player terminals (communication terminals or game apparatuses) of individual players matches two players connected to the server in the same period to realize a competitive game in which both players participate. However, the present invention is applicable to systems realized with any device configuration that enables the progression of electronic games in which multiple players participate. In this specification, “player” is described as referring to a user who logs in to and uses a competition service provided by a server 200 in this game system.

### Game System Configuration

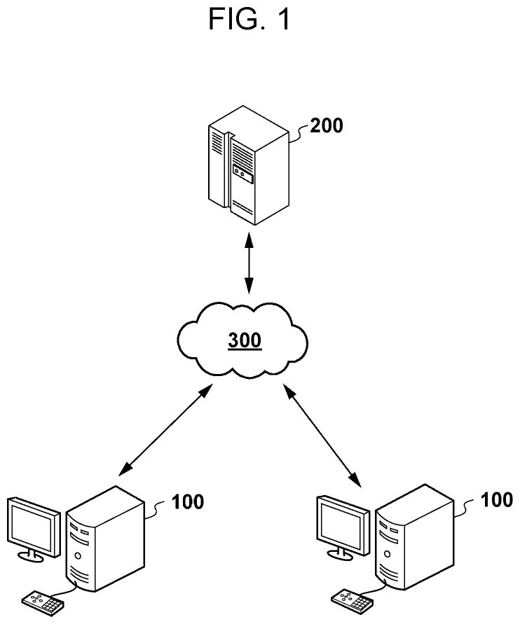

FIG. 1 is a diagram illustrating the configuration of a game system according to a present embodiment. As illustrated in this diagram, the game system is configured such that communication connection can be established between the server 200 and multiple player terminals 100 via a network 300. In the present embodiment, the server 200 matches, as the players of a competitive game, two players of player terminals 100 connected to the server 200, establishes a communication session for transmitting and receiving various types of information regarding the competitive game, and provides a competition service to realize a competitive game in which the two players participate.

Each player can log in to the competition service by launching a predetermined client application on the player terminal 100 used by the player. The client application allows the player to set various settings and make advance preparations for the competitive game to be executed, set player profile settings, and play the competitive game (match, solo play), for example. As described in detail below, suppose that the competitive game (electronic game) that can be played through the competition service according to the present embodiment is a trading card game (TCG) that progresses as players place game elements, such as cards, on a predetermined game field. The player terminals 100 may be any communication terminals having communication functions, such as personal computers (PCs) or smartphones.

### Hardware Configuration of Player Terminal

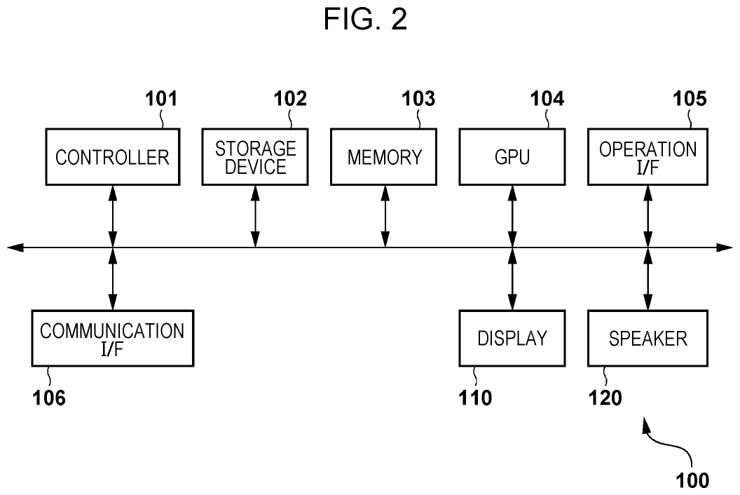

Next, the hardware configuration of the player terminal 100 will be described using FIG. 2. FIG. 2 is a block diagram illustrating an example of the hardware configuration of the player terminal 100.

A controller 101 is a processor, such as a central processing unit (CPU), and performs various types of control including operation control of each hardware device included in the player terminal 100. Specifically, the controller 101 performs corresponding control by, for example, reading out necessary programs stored in a storage device 102, loading the programs into a memory 103, and executing the programs.

The storage device 102 is a device capable of storing information permanently, such as a nonvolatile memory or a hard disk drive (HDD), for example. In addition to the operating system for operating the player terminal 100 and programs related to various types of applications, the storage device 102 stores information regarding parameters necessary to realize various types of control and various types of data used for display and communication functions for the browser. The memory 103 is a storage device used for temporary data storage, such as a volatile memory, for example. The memory 103 may be used not only as a loading area for each program but also as a storage area to temporarily store data and other data output in the course of various types of hardware operations and various types of control.

A graphics processing unit (GPU) 104 is a rendering device that performs various rendering processes related to generation of a display screen for the player terminal 100. The GPU 104 also executes a rendering process for the game screen displayed while the competitive game is being played. The GPU 104 includes a GPU memory, which is not illustrated, is loaded with various types of graphics data read out from the storage device 102, and performs predetermined arithmetic operations to generate various images. The screen and images generated by the GPU 104 are presented to the player by, for example, being displayed on a display 110 of the player terminal 100. The display 110 is a device, such as a liquid crystal display, for example, and is included in or detachably connected to the player terminal 100 to display information. The display 110 displays screens generated by the GPU 104.

An operation interface (I/F) 105 is a user interface of the player terminal 100 and accepts operation input. Upon detecting that an operation input has been made, the operation I/F 105 outputs a control signal corresponding to the operation input to the controller 101. In one mode, the operation I/F 105 includes various sensors and operation members, such as buttons provided on, for example, the exterior of the player terminal 100. The display 110 of the player terminal 100 according to the present embodiment is configured to be capable of detecting touch input, and the operation I/F 105 includes a touch input detection sensor provided on the display 110.

A communication I/F 106 is an interface for communicating with external devices of the player terminal 100. Information communication between the communication I/F 106 and the external devices may be performed via a wide area network (WAN), such as the Internet, a local area network (LAN), or the like. Information communication through the communication I/F 106 is described as being performed wirelessly, but this is not intended to exclude a wired mode.

A speaker 120 is an audio output interface included in the player terminal 100. The speaker 120 outputs various types of audio information including audio messages related to the client application.

### Hardware Configuration of Server

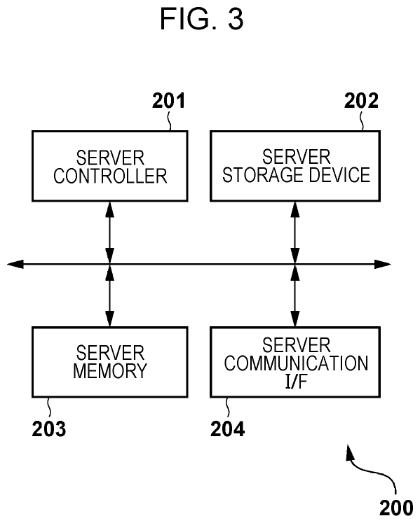

FIG. 3 is a block diagram illustrating a hardware configuration of the server 200 according to the present embodiment. Note that, in the following description, hardware configurations that realize substantially the same functions as the player terminal 100 will be prefixed with the word “server” to distinguish the configurations from those of the player terminal 100.

A server controller 201 is a processor, such as a CPU, and performs operation control on each hardware device included in the server 200, player management related to the competition service, and control to realize various functions including the matching function between players and transmission-reception and sharing of information regarding the competitive game to be executed. Specifically, the server controller 201 performs corresponding control by, for example, reading out necessary programs stored in a server storage device 202, loading the programs into a server memory 203, and executing the programs.

The server storage device 202 is a device capable of storing information permanently such as, for example, a nonvolatile memory or an HDD. In addition to the operating system for operating the server 200 and programs related to matching, the server storage device 202 stores information regarding parameters necessary to realize various types of control and various types of data necessary for providing the matching function. Suppose that the server storage device 202 also has a database function to manage information regarding each player registered as a player of the game system. The server memory 203 is a storage device used for temporary data storage, such as a volatile memory, for example. The server memory 203 may be used not only as a loading area for each program but also as a storage area to temporarily store data and other data output in the course of various types of hardware operations and various types of control.

A server communication I/F 204 is an interface for communicating with external devices of the server 200. Information communication between the server communication I/F 204 and the external devices may be performed via a wide area network (WAN), such as the Internet, a local area network (LAN), or the like. Information communication performed by the server communication I/F 204 may be wired or wireless.

### Overview of Competitive Game

The following is an overview of the competitive game through which play experiences are provided using the game system according to the present embodiment.

The competitive game is played using a predetermined field defined on the game. Each player builds a “deck” in which a set of game elements for the competitive game are registered and can play the competitive game using the deck the player has built.

To build a deck, each player needs to obtain game elements, for example, through a lottery feature available by paying a price. That is, the game elements that the player can include in the deck to be built are limited to game elements that the player has already obtained, for example. The number of decks that the player can build is not limited to one, and the player can build multiple decks in which at least one or more of the registered game elements is different.

Information regarding the game elements that the player has already obtained and the decks built by the player is managed by being registered in the server storage device 202 in association with identification information (a player ID) that uniquely identifies the player. In more detail, the server storage device 202 also functions as a database (DB) that manages, as player information, various types of information regarding each player. In certain player information serving as one record of the DB, the server storage device 202 manages a player ID, information regarding the game elements that the player has already obtained, and information regarding the deck(s) built by the player in association with each other.

For example, regarding the game elements obtained by the player, element IDs that uniquely identify the game elements and the number of game elements are included in the player information, so that the number of game elements the player owns can be managed. For example, regarding a deck built by the player, identification information of the deck (the deck ID) and the element IDs of the game elements included in the deck are included in the player information, so that the deck built by the player can be managed as information regarding the deck already built by the player (deck information).

As described above, the competitive game through which play experiences are provided using the competition service according to the present embodiment is a trading card game (TCG), and the game elements that are granted to the player and that can be used by being registered in the deck are (virtual) cards (which can be owned on the electronic game). In the competitive game according to the present embodiment, the cards that the player can use are classified into two types: leader card and member card, which have different roles in the competitive game, and the deck is required to include one leader card. In other words, a deck is built with one leader card and (one or more) member cards. Each card has a cost defined in accordance with the degree of favorability in the progression of the competitive game, for example. The player needs to register a group of cards to be included in the deck such that the total cost of the deck reaches a specified value.

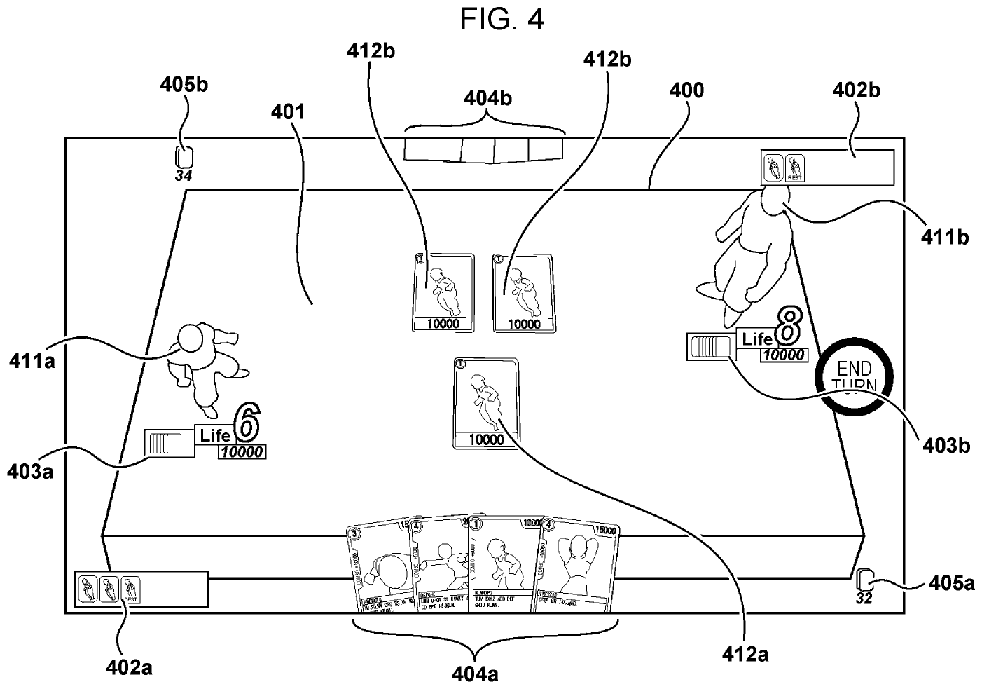

Similarly to as in previous TCGs, the competitive game progresses as a player and their opponent place cards registered in their respective decks onto individual areas of the field. In the competitive game according to the present embodiment, as illustrated on the game screen in FIG. 4, the game screen has multiple areas with different roles in addition to an area displaying a field 400, where presentation effects mainly related to the progression of the competitive game are displayed. In the example in the diagram, a battle area 401 is provided in the field 400, and an energy area 402 and a life area 403 are provided outside the field 400 or on the field 400 in an overlapping manner. On the battle area 401, cards that directly cause competitive actions in the competitive game are placed. In the energy area 402 and the life area 403, cards that do not directly cause competitive actions are placed. As illustrated in the diagram, the battle area 401 is configured as a common area for both players, and the energy area 402 and the life area 403 are configured as areas dedicated to each player.

The game screen illustrated in FIG. 4 is a screen presented to one of the players and is displayed on the display 110 of the player terminal 100 used by the one of the players. Thus, the field 400 in the game screen is configured such that the near side (lower part of the screen) of the field 400 corresponds to the player and the far side (upper part of the screen) of the field 400 corresponds to their opponent. To facilitate understanding of the invention, in the following description of the competitive game, the player using the player terminal 100 on which the game screen is displayed (the player assigned to the near side of the screen) is referred to as “player”, and the opponent player who competes against the player (the player assigned to the far side of the screen) as “opponent”. When there is no need to distinguish between the player and the opponent, “each player” or simply “player(s)” may be used. For the purpose of distinguishing display elements involving the player and those involving the opponent, the display elements involving the former are marked with a sign “a” and those involving the latter are marked with a sign “b”. In a case where there is no need to distinguish between the display elements involving the player and those involving the opponent, description will be made without the signs.

In the competitive game according to the present embodiment, each of the cards is associated with a character related to the content of the competitive game. For a character corresponding to a leader card (hereinafter referred to as “leader character”), a specified value of life (a parameter indicating the number of times the leader character can withstand an attack) is set at the start of the competitive game. In the competitive game according to the present embodiment, life is set to a fixed value of 8 for all leader characters to ensure fairness among the players. As described in detail below, life is one of the parameters involved in the end conditions of the competitive game, and is managed for each player in the communication session related to the competitive game.

During the competitive game, the life of the leader character related to each player is indicated using cards (eight cards at the start of the game) that are randomly extracted from the member cards included in the player's deck and placed in a face-down state (with the back facing up) on the life area 403 in the field. The life of the player is reduced by one in a case where an attack action taken by the opponent on the player's leader character, which serves as an action target, has succeeded. In this case, one member card is removed from a life area 403a and added to the player's hand. Note that the member cards placed on the life area 403 cannot be identified as any particular cards. Thus, instead of individually displaying the same number of face-down card images as the number of cards remaining, a combination of a predetermined number of representative card images and an indication of the number of cards remaining can be displayed.

Information regarding each card is associated with a unique card ID (element ID) as card information and is registered in the server storage device 202. In more detail, the server storage device 202 also functions as a database (DB) that manages various types of information regarding each card as card information, and manages the card information, which serves as one record of the DB. The card information includes the card ID uniquely identifying the card and information regarding the character associated with the card. In this case, the information regarding the character associated with the card includes the name of the character, graphics data of the character, and attribute information such as parameters that are referenced when the character is used in the competitive game.

A character's attribute information can include parameters that are referenced in a case where the character takes an action and include, for example, unique effects that are triggered when the character takes an action or when certain conditions are achieved in the competitive game. The character's attribute information can also include, for example, information regarding a character race. In order to place the character onto the battle area 401 in the field, a card of the character race is required to be consumed. As described in detail below, each character is assigned a race, and in order to place one character onto the battle area 401 and make the character ready for action, a member card associated with a character of the same race need be placed onto the energy area 402, which is different from the battle area 401, to ensure a consumable element (energy) (hereinafter referred to as “charge”) before placing the character. In this case, character races are not necessarily limited to biological classification, but can be a concept that indicates any classification established in relation to the game, such as color classification assigned for the game or teams defined in the content storyline.

The competitive game is a turn-based game, in which the player and the opponent take action turns alternately. Each player's action turn is generally constituted by an initialization phase, a charge phase, an operation phase, and a resolution phase. In the initialization phase, independent of the player's operational input, the card that performed an action and then entered an inactive state in the previous turn is reactivated, and a card is drawn from a draw pile 405 (the action of drawing a card and adding the card to a hand 404). In the charge phase, energy is charged by placing, onto the energy area, a card from the hand 404 of the player in the action turn. In the operation phase, on the condition that a card is placed from the hand 404 of the player in the action turn onto the battle area 401 by consuming the corresponding energy or that a card that is placed on the battle area 401 or a card that has already been placed on the battle area 401 is caused to enter the inactive state, the action of the corresponding character is determined. In the resolution phase, the action determined in the operation phase is resolved.

In this case, the charge phase and the operation phase are phases in which operation input made by the player is accepted, while the initialization phase and the resolution phase are phases in which operation input made by the player is not accepted. The operation phase and the resolution phase may occur multiple times in each player's action turn, depending on the cards included in the player's hand 404, the number of cards placed on the battle area 401, and the amount of energy charged.

The competitive game ends when the life of the leader character for one of the players reaches zero or the deck (the hand 404, the draw pile 405, and the member cards on the battle area 401) of one of the players reaches zero cards. That is, the player can win against the opponent by reducing the life of the leader character of the opponent to zero (by reducing the cards placed on a life area 403b to zero cards) or reducing the opponent's deck to zero cards first. The player loses to the opponent in a case where the life of their own leader character reaches zero (the cards placed on the life area 403a reach zero cards) or their own deck reaches zero cards before the opponent's.

As illustrated in FIG. 4, the game screen is configured in a manner where various GUIs overlap the field 400 serving as a base. In the example in the diagram, for each player, the hand 404 and draw pile 405 are displayed in addition to the battle area 401, the energy area 402, and the life area 403 described above. Note that, in an analog TCG, for example, a discard pile area is present where cards eliminated from the battle area 401 are placed; however, in the competitive game according to the present embodiment, cards to be discarded are controlled to be hidden from the game screen in order to present the progression of the competitive game to both players in an easy-to-see manner.

As the hand 404 of each player, a specified number of cards (for example, six cards) are drawn at the start of the competitive game. Furthermore, one card is drawn each time the player's action turn arrives. Thus, each player generally has one or more cards (member cards) as the hand 404 when their action turn arrives. The cards present in the hand 404 of each player are not placed on any area and are moved and placed onto either the battle area 401 or the energy area 402 through the player's operation.

On the game screen, the cards included in a hand 404a corresponding to the player are displayed in a face-up state, so that it is possible to identify each card. In contrast, the cards in a hand 404b corresponding to the opponent are displayed in a face-down state, so that it is not possible to identify each card. To ensure that it is not known which card will be drawn next from draw piles 405a and 405b, the draw piles 405a and 405b are configured so that only the number of remaining cards is visible. In a case where card placement is specified by the player in the charge phase of each action turn, a card is moved from the hand 404 and placed onto the energy area 402.

On the life area 403, the eight cards extracted at the start of the competitive game as described above are placed in a face-down state. Similarly to the draw piles 405, to ensure that it is not known what each card is until the card is eliminated as a result of an attack action and moved to the hand 404, the cards placed on the life area 403 are configured so that only the number of remaining cards is visible. As described above, life is treated as the leader character's durability count in the competitive game according to the present embodiment. Thus, as illustrated in FIG. 4, the life areas 403a and 403b are placed near the leader characters associated with the player and the opponent in a respective manner, as described below, and are displayed together with number images that represent the numbers of remaining cards.

As illustrated in the diagram, the battle area 401 is provided on the field 400. On the battle area 401, cards to be action executors in the competitive game are placed. To increase the entertainment value of the competitive game, the leader cards are placed on the battle area 401 in character form (three-dimensional models of the corresponding characters) rather than in card form. In the example in FIG. 4, a leader character 411a corresponding to the leader card included in the player's deck is placed at the near side of the battle area 401, and a leader character 411b corresponding to the leader card included in the opponent's deck is placed at the far side of the battle area 401. The leader characters 411a and 411b are displayed in the competitive game, and their appearances change as needed in accordance with player-induced actions or opponent-induced actions by which, for example, predetermined motions are applied or expressions of being hit are added.

In contrast, the member cards are placed on the battle area 401 in card form rather than in character form. In the example in FIG. 4, a member card 412a placed on the battle area 401 by the player is placed on the side (right side) of the leader character 411a, and member cards 412b placed on the battle area 401 by the opponent are placed on the side (left side) of the leader character 411b. Unlike the leader cards, the member cards 412 are always displayed in card form with their appearances unchanged.

In this manner, the leader card and member cards registered as each player's deck are placed on the battle area 401; however, these cards are represented in different appearances on the game screen. In the following description, these cards may be referred to as leader characters and member cards in accordance with the display form on the game screen; however, both of them may be referred to simply as “cards” because information management is performed treating both of them as cards in processing for the competitive game.

### Placement Area

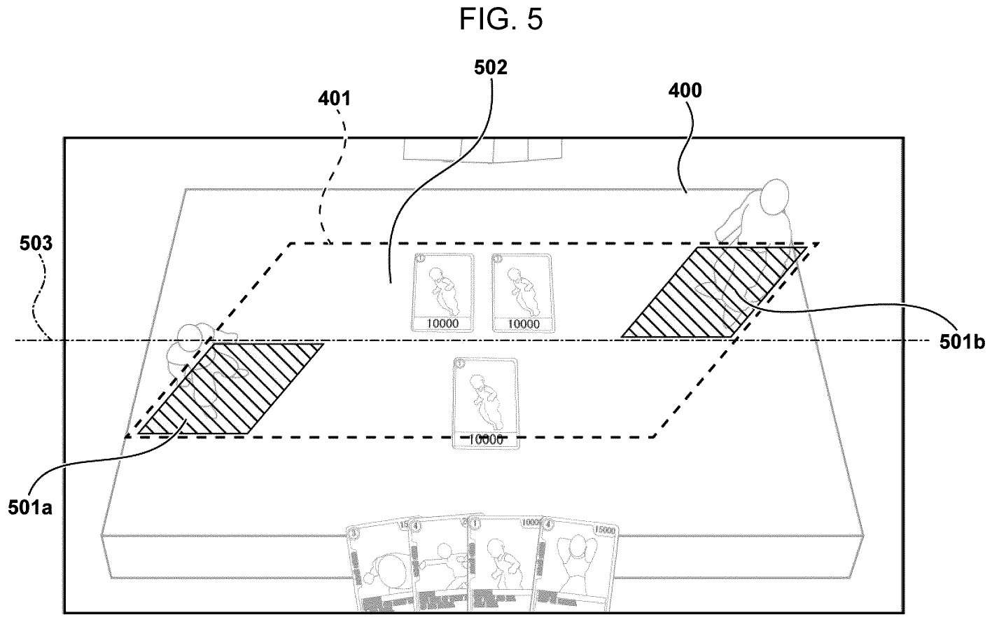

In the following, the placement of each card on the battle area 401 will be described in detail with reference to FIG. 5. As illustrated in FIG. 5, the battle area 401 is structured in a rectangular (parallelogram) shape. Note that the outer perimeter of the battle area 401 is illustrated with a broken line for illustrative purposes only in the example in the diagram, and the battle area 401 is not explicitly displayed on the field 400 as illustrated in FIG. 4.

The leader character 411a corresponding to the leader card of the player and the leader character 411b corresponding to the leader card of the opponent are placed on leader areas 501a and 501b, respectively. The leader areas 501a and 501b are located at diagonal positions, which are distributed at positions that are farthest apart on the battle area 401. In addition, the battle area 401 has a member area 502 in such a manner that the member area 502 is sandwiched between the leader area 501a and the leader area 501b. Member cards moved from the hand 404 of the player or opponent are placed onto the member area 502 in the operation phase in order to make those cards be ready for action.

The member area 502 is divided into the player side and the opponent side by a center line 503, which is represented by a single dotted line and extends through the vertical center of the battle area 401. The player side is below the center line 503 in the diagram, and the opponent side is above the center line 503 in the diagram. That is, member cards 412a of the player moved from the hand 404a onto the member area 502 are placed in a horizontally aligned manner in the lower part of that area. Member cards 412b of the opponent moved from the hand 404b onto the member area 502 are placed in a horizontally aligned manner in the upper part of that area. Although the center line 503 is not displayed on the game screen, the member cards 412a and the member cards 412b are placed so as to align horizontally at respective different vertical positions and are displayed so as to be spaced apart vertically with the center line 503 interposed therebetween in the member area 502. Thus, the player can easily distinguish the member cards 412a placed by themselves and the member cards 412b placed by the opponent.

To make it easier for the player to grasp the member cards 412b placed on the member area 502 by the opponent, the orientations of both member cards 412a and 412b are controlled so as to be displayed in their upright positions. That is, unlike in analog TCGs, in which the member cards 412b are displayed in their upside-down positions just because the upside-down positions are their upright positions as seen by the opponent, the display is controlled so that all cards can be seen in their upright positions on the game screen. In other words, in a manner where the standard orientation of display is such that the upward and downward directions defined for each member card 412 match the upward and downward directions of the game screen, both member cards 412a and 412b are placed on the member area 502 in the standard orientation and are displayed.

### Attribute Information Display

As described in detail below, in the competitive game according to the present embodiment, the player specifies the leader character 411a or a member card 412a placed on the field 400 (the battle area 401) to perform an attack action against the opponent's leader character 411b or member card 412b. The success or failure of the attack action is determined mainly on the basis of a “power” parameter included in the attribute information of each card.

Power can change sequentially in response to player-induced or opponent-induced actions, such as reducing the power of the opponent's character or card by activating a unique effect of the character or card, for example, in a case where certain conditions are met. Thus, in the present embodiment, the game screen displays the power of each card placed on the battle area 401 so that the players can easily grasp the power that may change as the competitive game progresses.

As illustrated in FIG. 4, such power display is performed in different manners for the leader characters 411 and the member cards 412. As described above, the member cards 412a and 412b are always displayed in card form on the battle area 401, so that their power values are displayed in their card areas, similarly to cards generally used in TCGs. In contrast, the leader characters 411a and 411b are displayed in character form on the battle area 401, and their appearances are controlled to change in order to suitably present the progression of the competitive game. Thus, the numerical value of power of each leader character is displayed at a position that is near but does not overlap the leader character.

### Attack Action

The following is a detailed description of attack actions required to achieve the end conditions of the competitive game. In the operation phase of the player's action turn, the player selects their own member card 412a as an action executor that executes an attack action, and also selects a card of the opponent (the leader character 411b or a member card 412b) as an action target, which is a target of the attack action. As a result, input for the attack action in the operation phase can be completed.

The player's cards that can be selected as action executors are those already placed on the battle area 401, and the player can make a selection from the leader card (the leader character 411a) and member cards 412a. The member cards 412a can include not only member cards already placed on the battle area 401 in the player's previously completed action turn, but also a member card placed by the player onto the battle area 401 from the hand 404a in the current action turn.

When the player performs an operation input on a card of their own placed on the battle area 401, one or more action options that can be specified for the card are displayed. By selecting an option related to an attack action from these options, the player can select the card as the action executor for the attack action. That is, the player enters a state where the attack action for the card is declared. In this case, the controller 101 of the player terminal 100 generates new action information that specifies the content of the attack action that the player desires to execute. The action information includes, for example, type information indicating the type of the action that the player desires to execute, and executor-target information grouping the action executor and its action target. Accordingly, the controller 101 generates new action information in which individual pieces of information are set to initial values, and updates, on the basis of the operation input related to the selection of the attack action and the selection of the action executor, the type information regarding the action information and information regarding the action executor in the executor-target information.

Thereafter, by selecting the leader card (the leader character 411b) or a member card 412b of the opponent, the player can select the card as the attack target of the attack action. In this case, the controller 101 updates, on the basis of the operation input related to the selection of the action target, information regarding the action target in the executor-target information. By updating the action information, the card serving as the action executor and the card serving as the action target are associated and enter a grouped state for the attack action that the player desires to execute. The action information is transmitted from the player terminal 100 used by the player to the server 200 via the communication I/F 106 and shared with the player terminal 100 of the opponent participating in the same communication session.

When an input related to the attack action is made in the operation phase, the success or failure of the attack action is determined in the subsequent resolution phase. The success or failure of the attack action is generally determined on the basis of a numerical comparison between the power of the character associated with the card of the action executor and the power of the character associated with the card of the action target. In the competitive game according to the present embodiment, the attack action is configured to succeed on the condition that the power of the former is greater than or equal to the power of the latter, and to fail on the condition that the power of the former is less than the power of the latter.

The effect produced by the success of the attack action differs depending on whether the action target is the leader card (the leader character 411b) or a member card 412b. In a case where the action target is the leader card, the life of the leader character 411b is reduced by one as a result of the attack action. That is, one of the opponent's cards placed on the life area 403b is eliminated. The eliminated card is not discarded but moved into the opponent's hand 404b. In a case where the action target is a member card 412b, the member card 412b is eliminated (discarded) from the battle area 401 as a result of the attack action. Note that in a case where the attack action has failed, even when the attack action is executed, the action is nullified, or the state of the action target remains unchanged before and after the execution.

When the resolution phase is completed for the attack action, the card selected as the action executor is set to be inactive so that no further actions can be taken in the current action turn. Since the leader card is displayed in character form (the leader character 411a) on the battle area 401, changing the appearance of the character unnaturally just because the leader card has entered the inactive state may reduce the tension of the competitive game. Therefore, the inactive state of the leader card may simply be indicated to the players by the inability to select the leader character 411a as an action executor, for example. In contrast, unlike the leader card, the member card 412a is not displayed in character form, and there is no inconvenience in the presentation even if the member card 412a is explicitly in the inactive state. Therefore, the inactive state of the member card 412a may be indicated to the players by a change in appearance, for example, by graying out the member card 412a, by rotating the member card 412a 90 degrees to a horizontal position, or by adding a display indication that the card is in the inactive state, for example.

Note that the member card 412b of the opponent that can be selected as the action target is limited to the member card 412b that is in the inactive state at that time, namely the member card 412b that took an action in the opponent's previous action turn. As described in detail below, the competitive game according to the present embodiment is configured such that in a case where an attack action is specified in the operation phase of the player's action turn, the opponent can take a defense action in response to the content of the attack action. In the defense action, a member card that is present in the opponent's hand 404b and that has not yet been placed at that time or a member card 412b that is in the active state at that time is allowed to participate as assistance.

That is, each player can select, as necessary, whether to take the risk of having the member card 412 placed on the battle area 401 perform an attack action against a card of the opponent and become the action target of an attack action by the opponent, or to take the safety measure of not performing an attack action against a card of the opponent in preparation for participation in a defense action and excluding cards from being action targets of an attack action by the opponent. By having the game configured in this manner, each player will come up with various strategies from the perspective of how to prepare for the opponent's action turn while maintaining the number of member cards 412 that can participate in defense actions, and how to make sure to reduce the number of member cards that can participate in a defense action during the attack action against the opponent's leader character, for example. As a result, the entertainment value of the competitive game is increased.

Thus, in a case where an operation input is made to select a member card 412b that is in the active state as the action target in the player's action turn, the controller 101 controls the display 110 to display a notification indicating that the selection is not possible.

### Display of Connecting Element

The number of cards placed on the battle area 401 may increase as the turns pass. Thus, for an attack action selected by each player, it is preferable to explicitly indicate the action executor and action target on the battle area 401. That is, display is preferred through which the player in the action turn can easily know whether or not they have input an attack action corresponding to the content desired by themselves and the player in the non-action turn can easily know the content of the attack action input by the opponent.

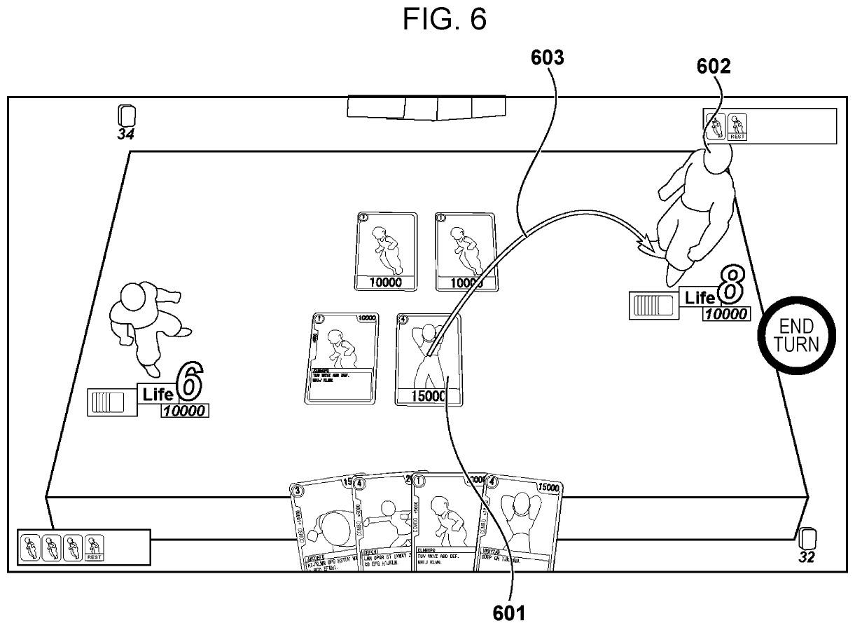

In the competitive game according to the present embodiment, when information regarding the cards indicating the action executor and action target is stored and grouped together in the executor-target information, a connecting element connecting between these cards is displayed on the game screen as illustrated in FIG. 6. The example in the diagram illustrates a situation in which a member card 601 of the player is selected as the action executor and a leader character 602 of the opponent is selected as the action target. A curved connecting element 603 connecting these is formed and displayed. As illustrated in the diagram, the connecting element 603 is used to display the card serving as the action executor and the card serving as the action target involved in the attack action in a different manner from other cards (the leader character and member cards) on the battle area 401. The connecting element 603 can thus make it easier for each player to grasp the content of the attack action being input in the operation phase. Moreover, the connecting element 603 is configured in the form of an arrow extending from the member card 601 to the leader character 602, and explicitly indicates the relationship between the action executor and the action target.

Based on these advantages of the connecting element 603, the competitive game according to the present embodiment is configured to display the connecting element 603 not only for the attack action whose content has been confirmed but also for when a card serving as the action target is selected after the card serving as the action executor is confirmed.

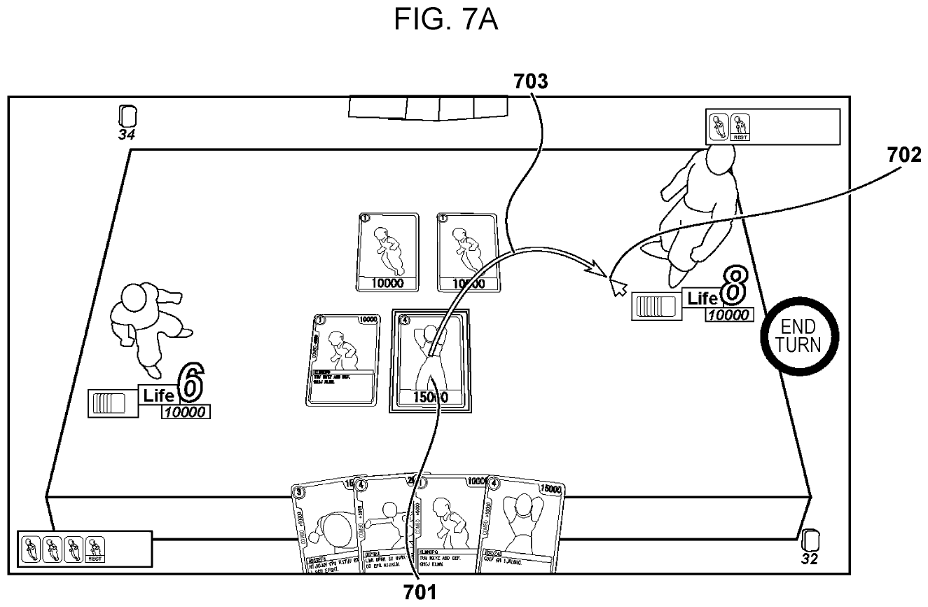

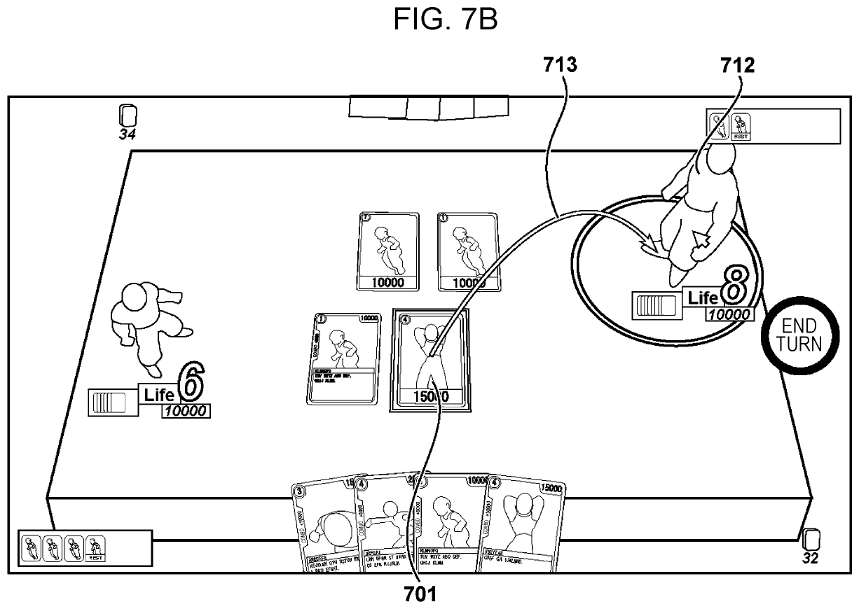

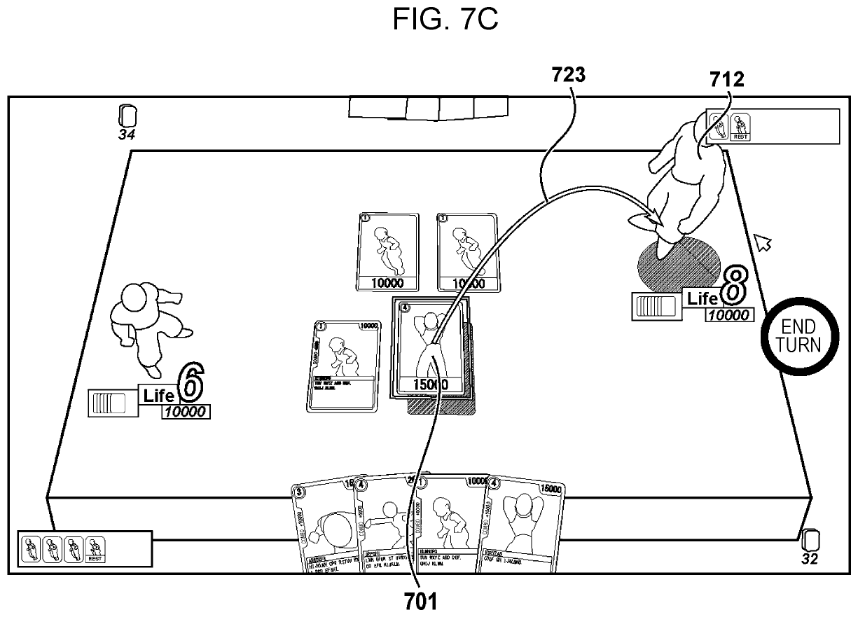

Specifically, the action target related to an attack action is configured to be definable in two stages: preliminary selection and final selection. First, as described above, when a card of the player (the leader character 411a or member card 412a) serving as the action executor of an attack action is selected, for example, display effects, such as glowing or color change, are added to the card such that the card is displayed to be identifiable in a different manner from the other cards on the battle area 401. Thereafter, in selecting a card of the opponent to serve as the action target, a connecting element 703 is displayed in a manner in which coordinates 702 in the game screen, where an instruction input is made by the player, and a card 701 serving as the action executor are connected as illustrated in FIG. 7A. In the competitive game according to the present embodiment, suppose that operation input made by the player is accepted through mouse operation, for example. In the embodiment, since the coordinates 702, where the instruction input is made using the mouse, and the card 701 serving as the action executor are connected by the connecting element 703, the connecting element 703 can let the player know at which position the instruction input is made.

When the instruction input, which is related to selection of the action target, enters (the mouse is hovered over) the area associated with one of the cards related to the opponent and placed on the battle area 401, the card enters the state of being preliminarily selected as the action target. In this case, the controller 101 assumes that the opponent's card over which the mouse is hovered is preliminarily selected as the action target, and tentatively sets, to the card, the information regarding the action target in the executor-target information. As a result, a connecting element 713 is displayed on the game screen in a manner in which a card 712, over which the mouse has been hovered, and the card 701, serving as the action executor, are connected on the basis of the tentatively set executor-target information, as illustrated in FIG. 7B. In other words, while the mouse is hovering over the area associated with the one card 712 of the opponent, the connecting element 713 is displayed in a fixed manner in which the card 701, serving as the action executor, and the preliminarily selected card 712, serving as the action target (the card being moused over), are connected regardless of the coordinates 702 where the instruction input is made. As illustrated in the diagram, similarly to the card 701 serving as the action executor, the preliminarily selected card 712 is also displayed in a manner with display effects added.

Furthermore, when an operation input for confirming the selection is made while the card is preliminarily selected, the preliminarily selected card 712 is selected as the action target. In this case, the controller 101 assumes that the opponent's card 712 that was tentatively selected at that time is finally selected as the action target, and updates the information regarding the action target in the executor-target information. When this final selection is made, the content of the attack action is confirmed, and the card 701 serving as the action executor and the card 712 serving as the action target are changed to float above the field 400, as illustrated in FIG. 7C, and are displayed in a further different manner from the other cards placed on the battle area 401. In this case, the display position of a connecting element 723 is adjusted to follow the floating card 701 serving as the action executor and the floating card 712 serving as the action target.

Although the example illustrated in FIGS. 6 to 7C illustrate a situation in which only certain cards are selected as the action executor and the action target, it goes without saying that it is possible to select other cards as the action executor and the action target. In this case, it goes without saying that the connecting element is formed in a manner that varies in length and shape in accordance with the position of the card serving as the action executor and the position of the card serving as the action target.

In order to increase the entertainment value of the competitive game, the attack action may be configured to trigger additional effects in a case where predetermined conditions are met. The predetermined conditions can be, for example, trigger conditions defined for the skills of a character associated with a member card serving as an action executor, the skills of the leader character, and so on.

The additional effects may generally be effects that transition the card, serving as the action executor, to a state that favors the progression of the competitive game. For example, the additional effects can include an effect that, upon a successful attack action against the leader character of the opponent, reduces the life of that character by two or more. Such an additional effect is preferably made known to each player at the time when the additional effect is triggered or when the situation is such that the trigger conditions can be met. Thus, in such a situation, when displaying the connecting element for determining the content of the attack action, a presentation effect of the connection between the card serving as the action executor and the card serving as the action target is displayed together with the connecting element. For the presentation effect, the direction of transition between the cards may be defined to make it known which card becomes advantageous or disadvantageous due to the activation of the additional effect. An example of the presentation effect is a lightning bolt moving along the connecting element from the card serving as the action executor to the card serving as the action target. Although the present embodiment is described in which the performance effect related to the additional effect is displayed together with the connecting element, the implementation of the present invention is not limited to this, and a certain presentation effect may be displayed in place of the connecting element.

### Combo

As described above, in the manner in which the success or failure of the attack action is determined on the basis of the magnitude of the power of the character associated with the card serving as the action executor and that of the power of the character associated with the card serving as the action target, each player can predict the result of the attack action without having to wait for the resolution phase. That is, if the result of an attack action is determined solely by the power related to the action executor and the power related to the action target, the player who is able to place a card with a higher power value than any card of the opponent onto the battle area 401 will have the advantage, and it will be difficult to reverse that player's advantage. For example, if the player simply selects, as the action executor, a card that has more power than the opponent's leader character and attacks that leader character eight times, a situation may arise where the player will definitely win. In other words, if the result of an attack action is determined solely by the power of the two cards of interest, there is little uncertainty in the progression of the competitive game, and this may reduce the entertainment value of the competitive game.

For this reason, the competitive game according to the present embodiment has a “combo” function. Through the “combo” function, for an attack action specified in the operation phase, the player in the action turn adds a card to the card serving as the action executor to assist the attack action, and the player in the non-action turn adds a card to the card serving as the action target to assist a defense action against the attack action. The combo function is a function through which when a card already placed on the battle area 401 (the leader character 411 or a member card 412) is to take an action, another card that serves as assistance is linked to the card that is to take an action. This linking can increase the power value of the card that is to take an action. In the following, linking another card that serves as assistance will be simply referred to as “creating a combo”.

In more detail, when it is the player's action turn, in the operation phase, the player can create a combo by linking the member card 412a that is in the active state and that is also placed in the battle area 401 or a member card that is included in the hand 404a to a single card (the leader character 411a or member card 412a serving as the action executor) that is on the battle area 401 and for which an attack action has declared. In contrast, in the resolution phase, the opponent can create a combo by linking a member card 412b that is also placed on the battle area 401 and that did not enter the inactive state (that is in the active state) in the opponent's most recent action turn or a member card that is included in the hand 404b to a single card (the leader character 411b or a member card 412b) in the battle area 401 specified as the action target by the player.

The number of member cards (hereinafter also referred to as “combo cards”) to be linked to a single card, which is to take an attack action or a defense action (hereinafter referred to as “action card”), to create a combo can be freely determined by each player. However, it goes without saying that the number of member cards that can be linked to create a combo is limited to the number of member cards 412 that are in the active state and that are placed on the battle area 401 and the number of member cards present in the hand 404. Since the player whose deck reaches zero cards first loses the competitive game, each player needs to strategically choose whether or not to create a combo for each attack action.

A combo for an action card can be created by accepting an operation for moving a combo card onto a predetermined area (hereinafter referred to as “combo area”) on the game screen. This operation is hereinafter referred to as “combo operation”. Unlike the life area and energy area, which play the same roles throughout the competitive game and always need to present the card placement status, the combo area is an area that needs to be displayed only during attack action periods (from the declaration of each attack action to its resolution). In addition, since the action card is determined by the player's operation related to the attack action, if the combo area is set up at a fixed position, there is a possibility that the player cannot intuitively perform a combo operation, especially in cases where the action card and the combo area are spaced apart. That is, there is a possibility that the player cannot intuitively grasp that they are performing a combo operation on the action card.

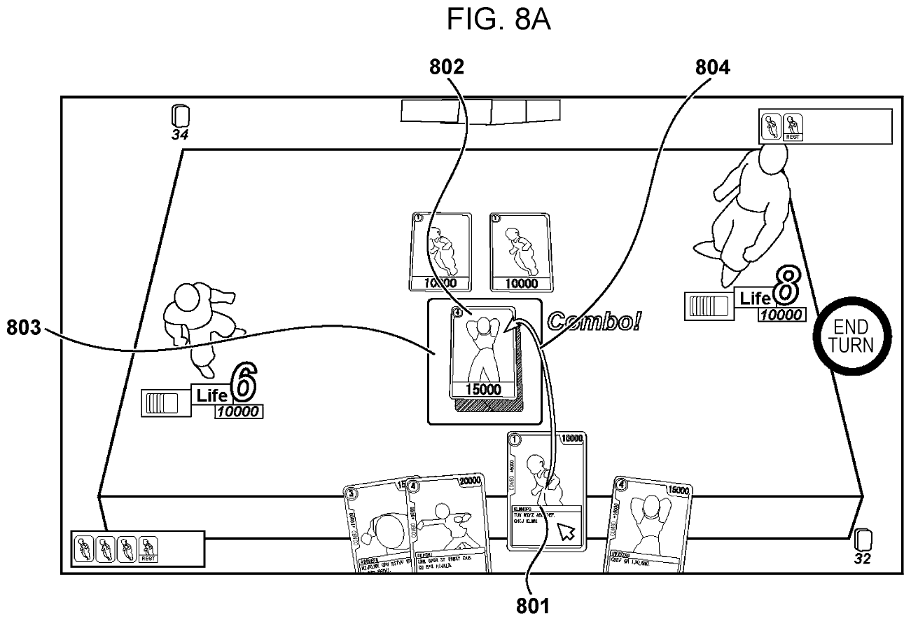

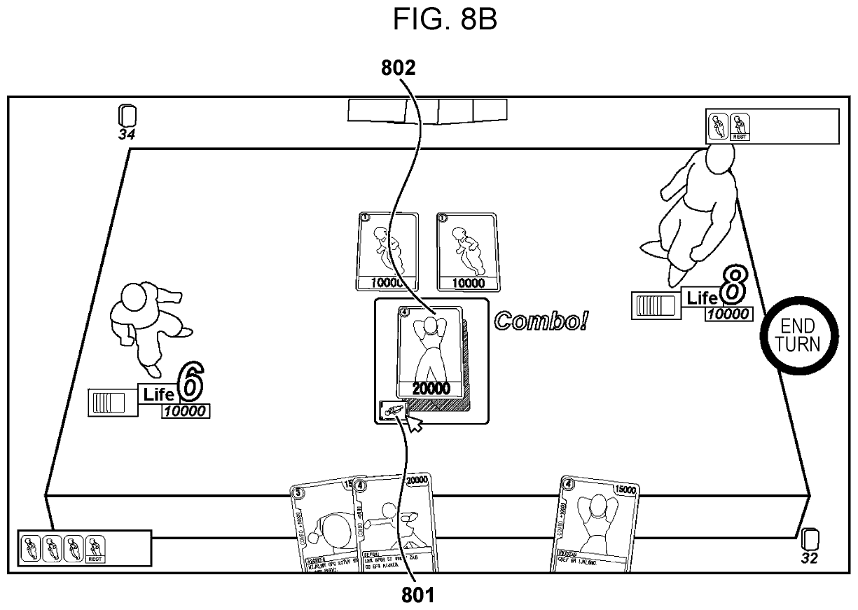

Thus, in the competitive game according to the present embodiment, as illustrated in FIG. 8A, only while a combo card 801 is selected to perform a combo operation (during a period when a selection operation input for the combo card 801 (for example, a drag operation performed on the combo card 801) is continued), a combo area 803 is displayed at the position of an action card 802. The example in the diagram illustrates the game screen displayed in a case where the player in the action turn is trying to create a combo by linking the combo card 801 in the hand 404a to the action card 802, which is selected as the action executor. Since multiple cards can be placed on the battle area 401, the combo area 803 displayed at the position of the action card 802 in this way allows the player to grasp the position on the screen to which the combo card 801 is to be moved. Furthermore, a curved connecting element 804 connecting the combo card 801 and the action card 802 is displayed to notify that the combo card 801 needs to be moved onto the combo area 803 in order to create a combo with the action card 802.

The connecting element 804 is configured in the form of an arrow extending from the combo card 801 to the action card 802 and indicates the position to which the combo card 801 needs to be moved to create a combo. In this case, the connecting element 804 related to the combo operation and the connecting element related to input of the content of the attack action differ as follows. The former forms an arrow extending from the coordinates where the instruction input is made (coordinates in the combo card 801) onto the combo area 803 (the action card 802), and the latter forms an arrow extending from the card serving as the action executor to the coordinates where the instruction input is made (or the card serving as the action target, the instruction input being made in the area of the card).

The connecting element 804 is displayed, and its shape changes to track the position of the combo card 801, similarly to the connecting element related to input of the content of the attack action. At least while the combo card 801 is being moved through operation, the action card 802 and the combo area 803 are displayed without moving in the battle area 401. Thus, the connecting element 804 is displayed with one end fixed.

The combo operation is completed when the combo card 801 is moved onto the combo area 803 and is deselected (by performing a drag and drop operation), and the combo card 801 enters a combo state in which the combo card 801 is linked to the action card 802. When the combo operation is completed, the display of the combo area 803 and connecting element 804 ends, and the combo card 801 in the combo state is placed near the action card 802 in a placement manner related to the inactive state (a horizontal orientation in the example in the diagram), as illustrated in FIG. 8B.

In this case, the controller 101 also generates or updates combo information indicating the content of the combo related to the action card 802. For a combo card to be linked to the action card to create a combo, the combo information includes, for example, a card ID uniquely identifying the action card, a card ID uniquely identifying the combo card, and change information indicating changes occurring in attribute information of the action card as a result of creating a combo with the combo card. That is, the action card and the combo card are grouped using the combo information.

In the competitive game according to the present embodiment, suppose that creating a combo increases the power value of the action card, and the change information stores information indicating the increase in power value (such as +5000) as a result of creating a combo. The increase in power value as a result of creating the combo may be specified in, for example, the card information regarding the combo card, and may also be indicated in the appearance of the member card displayed on the game screen. In response to the completion of the combo operation, the power value displayed for the action card is changed in such a manner that the change as a result of creating the combo is reflected. In the example in the diagram, the power of the action card 802, which was “15,000” in FIG. 8A before creating the combo, has increased to “20,000” in FIG. 8B after the combo operation is completed. The combo information configured in this manner is sent out to the server 200 and also transmitted to the player terminal 100 used by the opponent.

Thus, it is important for the players to grasp various types of attribute information of cards that may be involved in attack actions (or defense actions) in the progression of the competitive game. Thus, in the competitive game according to the present embodiment, a card detail window is configured to be displayable at any time during the progression of the game. The card detail window displays, for each card placed on the battle area 401 and each card in the hand, various types of attribute information, such as the power value of the associated character and the increase in power value as a result of creating a combo. The card detail window may be displayed on the game screen, for example, in response to an operation input such as right-clicking on a card for which display of attribute information is desired, while the mouse is hovering over the card.

In a case where a combo is confirmed, the game screen may be configured to display, for example, a presentation effect indicating that the action related to the action card is enhanced by creating the combo, when the action related to the action card is executed. As described above, multiple combo cards can be linked to a single action card to create a combo in the competitive game according to the present embodiment. Thus, the increase in power value as a result of creating a combo tends to increase as the number of combo cards to be linked to create the combo increases. That is, as the number of combo cards to be linked to create a combo increases, the power value increases, so that the success rate of the action can increase. For this reason, when the action related to the action card is executed, the game screen may be configured to display a presentation effect corresponding to the number of combo cards linked to create a combo.

### Awakening

In the competitive game according to the present embodiment, in addition to the combo function, a card awakening function is provided as an entertaining element that allows the success or failure of attack actions to differ, in order to facilitate a balanced and competitive game flow. Card awakening is a function that can be used only once for each leader card, on the condition that a predetermined conditions is met in the progression of the competitive game.

The predetermined condition under which the awakening function is usable can be that, for example, the life of the leader character is reduced by half. That is, in a case where eight lives are allocated to the leader character at the start of the competitive game, the player can use the awakening function of the leader character in their action turn when the life of the leader character is four or less.

When the awakening function of the leader character is used, the leader character changes into an awakened character with a different appearance, and its attribute information including power changes. In this case, the awakened character with the different appearance may be the same character as the leader character but in a different state, or may be a different character from the leader character. The attribute information of the awakened character with the different appearance is generally set to a state that more greatly favors the progression of the competitive game than that of the leader character, and this makes it easier for the disadvantaged player to shift the battle in their favor. The change in appearance may be expressed by replacing the three-dimensional model of the leader character with a three-dimensional model of the awakened character in the process of rendering the game screen, or by adding a predetermined display effect to the three-dimensional model of the leader character.

Which awakened character the leader character will be can be confirmed through the card detail window related to the corresponding leader character. The card detail window may be configured as follows. The card-form appearance and attribute information of the leader character associated with the front side of the leader card are displayed in the initial state, the display is switched to the appearance of the back side of the leader card in response to a predetermined operation input, and the attribute information of the awakened character associated with the back side of the leader card is displayed.

### Resolution

In the solution phase, the process related to action resolution is performed for an attack action instructed by the player in the action turn. The process is performed on the basis of the content of a combo operation performed by the player in the action turn on the card serving as the action executor and the content of a combo operation performed by the player in the non-action turn on the card serving as the action target. In the game system according to the present embodiment, the action resolution process is performed by the server controller 201, and information regarding the result is described as being shared via a communication session to the player terminal 100 used by each player participating in the competitive game. However, the implementation of the present invention is not limited to this, and it goes without saying that the controller 101 of the player terminal 100 used by the player in the action turn or the controller 101 of the player terminal 100 used by the player in the non-action turn may perform the process related to the action resolution.

As described above, whether or not an attack action instructed by the player in the action turn will succeed is determined on the basis of the magnitude of the (post-combo) power value of the card serving as the action executor and that of the (post-combo) power value of the card serving as the action target. More specifically, the server controller 201 determines that the attack action will succeed in a case where the power value of the card serving as the action executor is greater than or equal to the power value of the card serving as the action target. The server controller 201 determines that the attack action will fail in a case where the power value of the card serving as the action executor is less than the power value of the card serving as the action target.

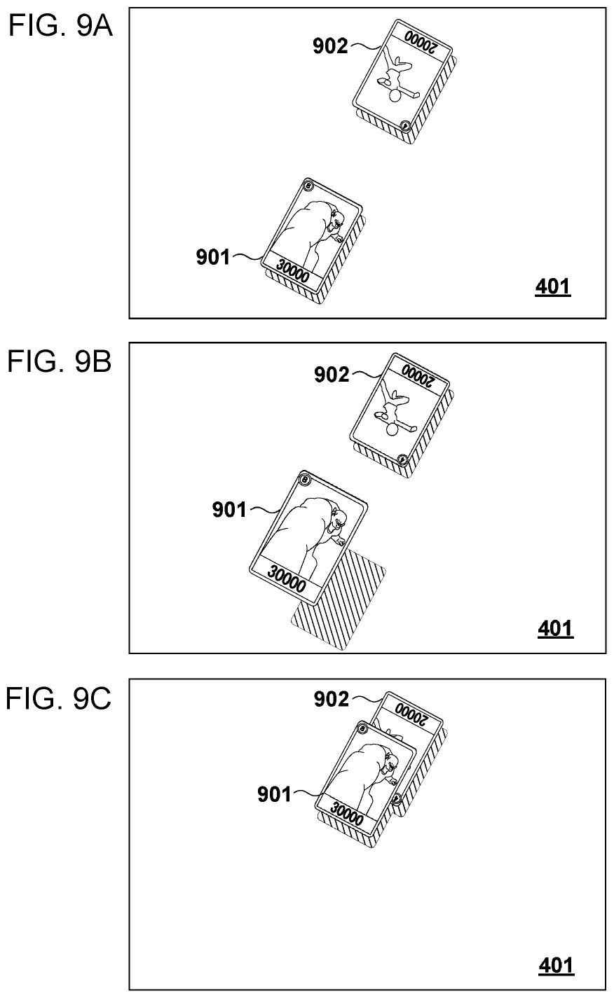

In a case where the attack action succeeds, display related to the attack action is displayed on the game screen. When the attack action begins, as illustrated in FIG. 9A, the connecting element is first hidden, the orientation of a card 901 serving as the action executor and the orientation of a card 902 serving as the action target are changed so that their tops face each other. This orientation change can explicitly indicate on which of the opponent's cards the card 901 serving as the action executor will take the attack action, or from which of the opponent's cards the card 902 serving as the action target will receive the attack action.

When the orientation change of the card 901 serving as the action executor and the orientation change of the card 902 serving as the action target are completed, the presentation of the attack action will begin. The presentation effects can be constituted by a series of movements. For example, the card 901 serving as the action executor floats further from the battle area 401 as illustrated in FIG. 9B, moves to the position of the card 902 serving as the action target as illustrated in FIG. 9C, collides with the card 902, and then returns to its original position.

After the display of the presentation effects, the handling of the card serving as the action target varies in accordance with the type of the card. In a case where the card serving as the action target is a leader card, the server controller 201 subtracts one life from the life of the leader character related to the player in the non-action turn. As a result of the life subtraction, one card is moved from the life area related to the player in the non-action turn to the player's hand on the game screen. Note that in a case where the life becomes zero as a result of the life subtraction, it is easily understood that the display content of the game screen will transition to the display related to the end of the competitive game. Moreover, in a case where the card serving as the action target is a member card, the server controller 201 performs processing for eliminating the card from the battle area 401. In this case, the presentation effects, being torn and eliminated from the field 400, of the card serving as the action target are presented on the game screen.

After the display of the presentation effects of the attack action, the card serving as the action executor is controlled to be in the inactive state and becomes inoperable. In addition, the cards in the combo state by being linked to the card serving as the action executor and to the card serving as the action target are eliminated from the field 400 after the display of the presentation effects, and the cards are no longer displayed in the progression of the competitive game, that is, those cards are controlled to remain uninvolved in the progression of the competitive game.

### Field Display

The following describes display control of the field 400 in the game screen for the competitive game according to the present embodiment that progresses in this manner.

As described above, the display of each leader character is configured using a three-dimensional model. Thus, the display of the field 400 is generated by placing a three-dimensional model of the field, which will be the ground on which the leader characters and member cards are placed, three-dimensional models of the leader characters, and if necessary, three-dimensional models of the member cards in a predetermined three-dimensional space, and rendering these from a viewpoint (camera) positioned in the same space. These three-dimensional models are hereinafter referred to as “field model”, “character model”, and “card model”. That is, two character models and, if necessary, one or more card models are placed on the field model in the three-dimensional space, and the movement of the character models and card models is controlled in accordance with the progression of the competitive game. As illustrated in FIG. 4, for example, various camera parameters are set such that the camera produces a bird's-eye view image of the field 400, mainly the battle area 401, from the player's side, and captures the way in which the character models and card models on the field model operate within the angle of view.

In TCGs, card operations performed in each action turn may need to be carried out strategically, assuming attack actions that are planned to be taken in subsequent action turns, attack actions that the opponent may perform, and so on. Various methods of progression can be used based on the strategies devised by each player. Specifically, for example, the player may delay placing member cards from their hand onto the battle area 401 in consideration of the power, skill, and other attributes of member cards placed on the battle area 401 related to the opponent, or place many member cards onto the battle area 401 in a single action turn to deter the opponent from taking attack actions. Thus, in TCGs, each action turn is configured to end with a declaration made by the player, and the length of a single action turn can vary at the player's discretion.

In contrast, there are also restrictive factors that limit the player's card operations in a single action turn. For example, cards in the battle area 401 that have entered the inactive state will be inoperable until the next action turn, and a member card in the hand cannot be placed onto the battle area 401 in a case where the remaining energy count is insufficient. The occurrence or duplication of such restrictive factors can lead to a situation in which the player cannot perform any card operations in their action turn and can only declare the end of the turn. However, when the player is unfamiliar with the competitive game, especially when the player is a beginner, it may take time for the player to recognize being in such a situation, and the playing time of the competitive game may be prolonged.

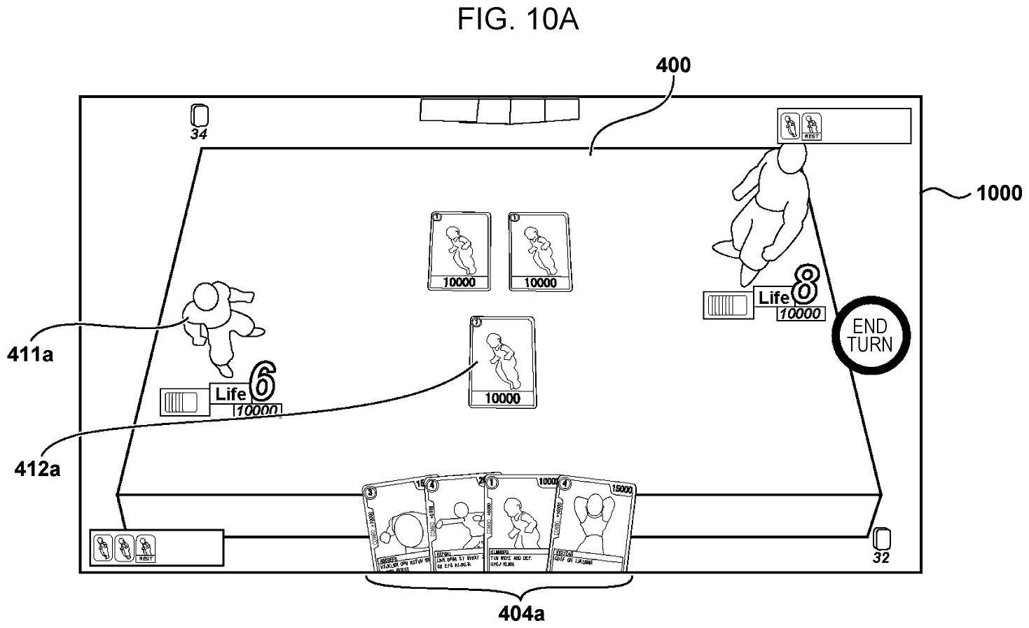

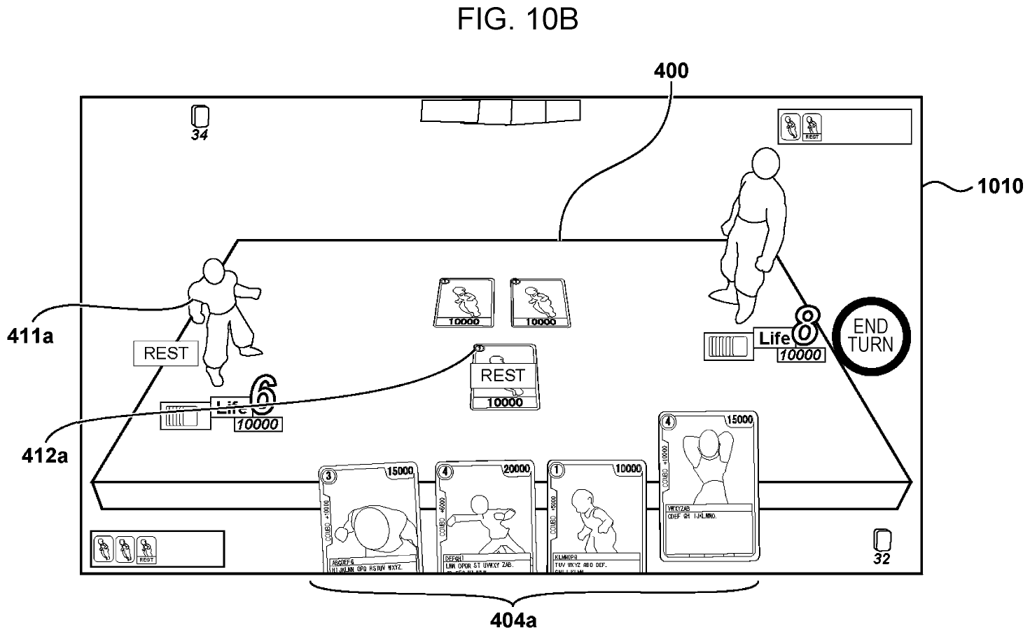

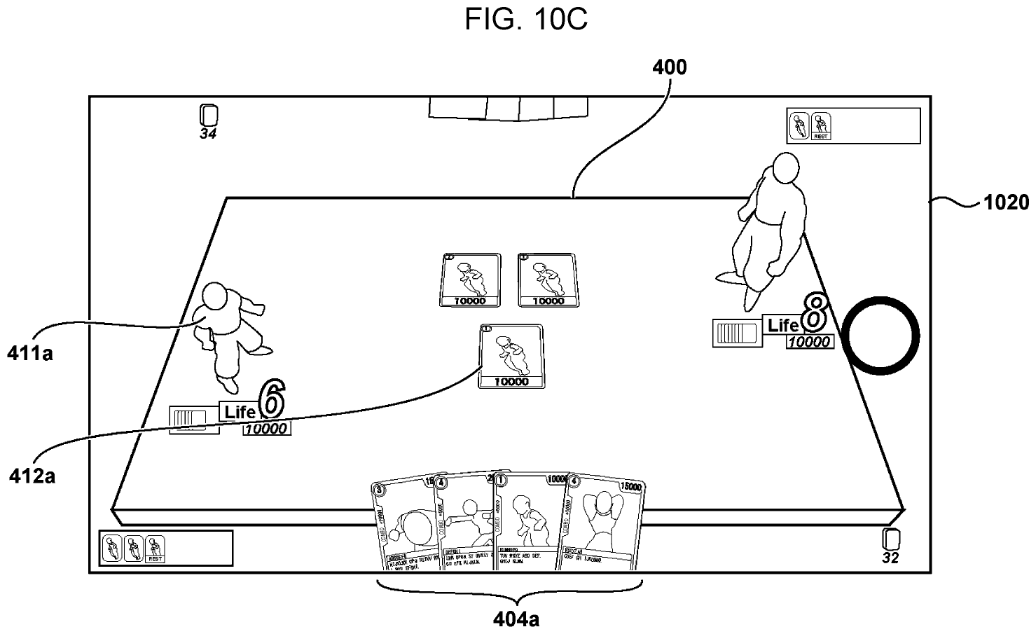

Thus, in the competitive game according to the present embodiment, in phases that require the player's operation input, control is performed to generate a game screen on which the display form of the field 400 is varied in accordance with the progression of the competitive game so as to guide the player to perform necessary operations. The display form of the field 400 is changed by changing the position and posture of the camera that renders the three-dimensional space in which the various three-dimensional models are placed. In the phases that require the player's operation input, the field 400 is displayed on the game screen mainly in two display forms, as illustrated in FIGS. 10A and 10B.

A game screen 1000 in FIG. 10A illustrates a display form of the field 400 in a case where actionable cards are present on the field 400 in the phases that require the player's operation input. In order that the player can easily focus on the cards (the leader character 411a and member card 412a) related to themselves on the field 400, the display form is rendered using a first camera parameter set such that the display area of the field 400 in the game screen becomes larger than a predetermined area threshold (or the area percentage of the image of the field 400 in the game screen becomes larger than a predetermined value). The game screen 1000 is displayed, for example, in a case where an actionable card (the leader character 411a or the member card 412a in the active state) is present on the field 400 in the operation phase of the player's action turn.

In contrast, a game screen 1010 in FIG. 10B illustrates a display form of the field 400 in a case where no actionable cards are present on the field 400 in the phases that require the player's operation input. In order that the player's attention is drawn away from the cards related to themselves on the field 400, the display form is rendered using a second camera parameter, which sets the camera at a position further away from the field 400 than the first camera parameter sets. As illustrated in the diagram, the game screen 1010 is configured such that the display area of the field 400 becomes smaller than the area threshold (or the area percentage of the image of the field 400 on the game screen becomes smaller than the predetermined value). Thus, according to the second camera parameter, the display area of the field 400 is smaller than when rendering is performed with the first camera parameter. The game screen 1010 is displayed, for example, in a case where no actionable cards are present on the field 400 in the operation phase of the player's action turn. The game screen 1010 is also displayed in the charge phase of the player's action turn. The game screen 1010 in such a form can inform the player that there is nothing the player can do (no card operation can be performed) for the cards placed on the field 400.

In addition, on the game screen 1010, the cards in the hand 404a are displayed in a more emphasized manner than the game screen 1000, so that the player is more likely to focus on the cards in the hand 404a than to the cards related to themselves on the field 400. In the example in FIG. 10B, the hand 404a is emphasized by making the display area of the hand 404a larger than that on the game screen 1000.

In the examples of the game screens 1000 and 1010 illustrated in FIGS. 10A and 10B, for example, an inoperable card in the field 400 is illustrated in the form of an inactive state (in the example in the diagram, the text image “REST” is added to indicate that the card is in the inactive state). This indicates that the card is unavailable for operation input. However, the implementation of the present invention is not limited to this. For example, in order to inform the player of cards that are available for operation input, the game screen 1000 and the game screen 1010 may display, in the field 400 or in the hand 404a, cards that are available for operation input in an emphasized manner. The emphasized manner can use effects such as, for example, emitting light around the peripheries of the cards that are available for operation input.

In the description above, mainly in the player's action turn, the game screen 1000 and the game screen 1010 are described as switching therebetween in accordance with the presence or absence of actionable cards on the field 400. In contrast, the phases that require the player's operation input are not limited to those in the player's action turns. That is, even in the opponent's action turn, the player can input operations for defense actions in the resolution phase for a case where an attack action is specified by the opponent. In this case, at least the player's card selected as the action target forcibly enters an operable state (a state in which the card can be specified to be linked to for creating a combo), regardless of whether or not the card entered the inactive state in the most recent action turn of the player. Thus, in the resolution phase of the opponent's action turn, the field 400 is treated assuming that actionable cards are present thereon, and the field 400 is rendered using the first camera parameter. In other words, in the resolution phase of the opponent's action turn, the field 400 is always displayed in the display form of the game screen 1000.

In contrast, in phases that do not require the player's operation input, the field 400 is displayed on the game screen in the display form as illustrated in FIG. 10C. A game screen 1020 displayed in these phases is displayed in a situation in which operation input made by the player is not accepted. Thus, there is no need to display the field 400 with a display area greater than or equal to the area threshold as in the game screen 1000, or to perform emphasized display for the hand 404a as in the game screen 1010. In other words, the game screen 1000 and the game screen 1010 are game screens configured to facilitate operation input to the player's cards placed on the field 400 or cards in the hand 404a, respectively. However, in the phases that do not require the player's operation input, it is not necessary to display the field 400 in the display forms suitable for operation input. Thus, the display form of the field 400 on the game screen 1020 is rendered using a third camera parameter, which is intended to appropriately display the presentation effects of the battle progression on the field 400.

The third camera parameter is a camera parameter set so that the entirety of all three-dimensional models (the field model, character models, and card models) in the three-dimensional space is included in the angle of view. As described above, in the competitive game according to the present embodiment, the presentation effects of the battle, in which the card serving as the action executor and card serving as the action target are operated, are displayed in the resolution phase. Thus, the third camera parameter is changed adaptively in order to present, to the player, the way in which the battle is performed in a more realistic display manner. That is, since the spatial positions of the character models and card models and the forms (appearances) of the character models can change in accordance with the progression of the competitive game, the third camera parameter may be adjusted to capture those models within the angle of view, taking their placement relationship into account each time. For example, in a situation in which the leader character becomes huge due to awakening, the third camera parameter may be adjusted to different values before and after awakening so that the character model's entire body is included in the angle of view.

Thus, in the player's action turn, the camera that renders the field 400 transitions to the third camera parameter in the initialization phase, to the second camera parameter in the charge phase, to the first camera parameter (if a card in the active state is present on the field 400) or the second camera parameter (if a card in the active state is not present on the field 400) in the operation phase, and to the third camera parameter in the resolution phase. Moreover, in the opponent's action turn, the camera that renders the field 400 transitions to the third camera parameter in the initialization phase, to the third camera parameter in the charge phase, to the third camera parameter in the operation phase, and to the first camera parameter in the resolution phase. Even in the resolution phase of the opponent's action turn, in a case where a member card in the hand 404a that can be selected to perform the combo operation is not present (a case where the player has zero cards in their hand and this is a phase in which it is practically impossible to perform operation input), the camera may be configured to select the third camera parameter.

A comparison of these three display forms related to the field 400 also indicates the following relationship. The display area of the field 400 in the game screen reaches its maximum in a case where the first camera parameter is used (the game screen 1000). That is, the first camera parameter does not change the angle of view, for example, in accordance with the states of various three-dimensional models, unlike the third camera parameter. Thus, the display area of the field 400 can be held at maximum in a fixed manner, so that the display form can be provided through which operation input to the cards placed on the field 400 is easiest. In the phases that require the player's operation input, part of the field 400 is displayed (the game screen 1000, the game screen 1010), while in the phases that do not require the player's operation input, the entire field 400 is displayed (the game screen 1020).

Note that the appearance of the field 400 has not changed in the example illustrated in FIGS. 10A to 10C, but the appearance of the field 400 may be configured to change in accordance with the progression of the competitive game in order to increase the entertainment value of the competitive game. Changes in the appearance of the field 400 can include, for example, a reduction in life, the occurrence of attack actions involving combos, and the addition of ground damage or collapse effects in response to the awakening of the leader character.

### Competitive Game Process

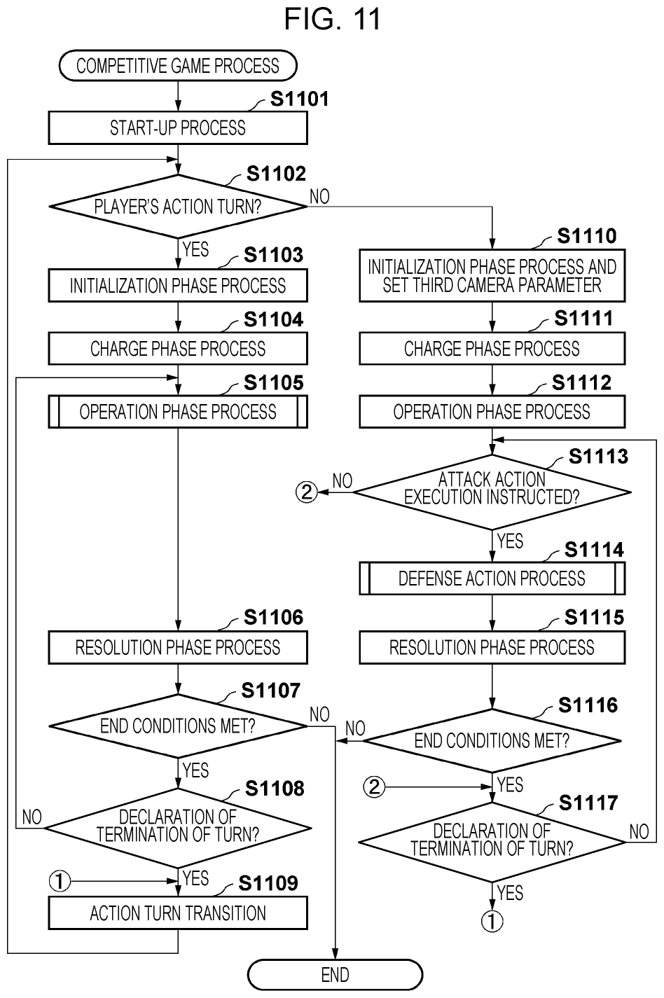

The flowchart in FIG. 11 describes the specific process of the competitive game process executed to provide competitive gameplay experiences on the player terminal 100 according to the present embodiment, which has such a configuration. The process corresponding to the flowchart can be realized by the controller 101, for example, reading out the corresponding processing program stored in the storage device 102, loading the processing program into the memory 103, and executing the processing program. Note that this competitive game process, for example, is described as starting when the server 200 completes matching with an opponent. In addition, in this competitive game process, some processes in a display control process related to the competitive game, such as the application of motion to character models and presentation effect display, etc., are the same as those in the display control for existing games. Thus, there may be cases where the description is omitted, but this does not limit the execution of such processes in the implementation of the present invention. The information necessary to perform display on and control each player terminal 100 is generally calculated by the server 200 and provided to each player terminal 100 each time in order to synchronize the progression of the competitive game between the player terminal 100 used by the player and the player terminal 100 used by the opponent. Such description may be omitted in order to facilitate understanding of the invention.

In S1101, the controller 101 performs a start-up process related to the start of the competitive game. The start-up process includes displaying each player's profile and leader card introduction, shuffling the draw pile, selecting the initial hand, and determining the first and second players in a turn-based game. These processes may be performed on the basis of information acquired from the server 200.

In S1102, the controller 101 determines whether or not the current action turn is the player's action turn. In a case where the controller 101 determines that it is the player's action turn, the process proceeds to S1103. In a case where the controller 101 determines that it is the opponent's action turn, the process proceeds to S1110.

In S1103, the controller 101 executes an initialization phase process related to the player's action turn. The initialization phase process includes making member cards 412a placed on the field 400 related to the player and member cards placed on the life area 403a enter the active state, and drawing one member card from the draw pile 405a and adding the member card to the hand 404a. Moreover, the controller 101 sets the third camera parameter for rendering the field 400.

In S1104, the controller 101 performs a charge phase process related to the player's action turn. The charge phase process causes one member card selected from the hand 404a to be placed onto an energy area 402a. Moreover, the controller 101 sets the second camera parameter for rendering the field 400.

In S1105, the controller 101 performs an operation phase process related to the operation phase of the player's action turn.

### Operation Phase Process

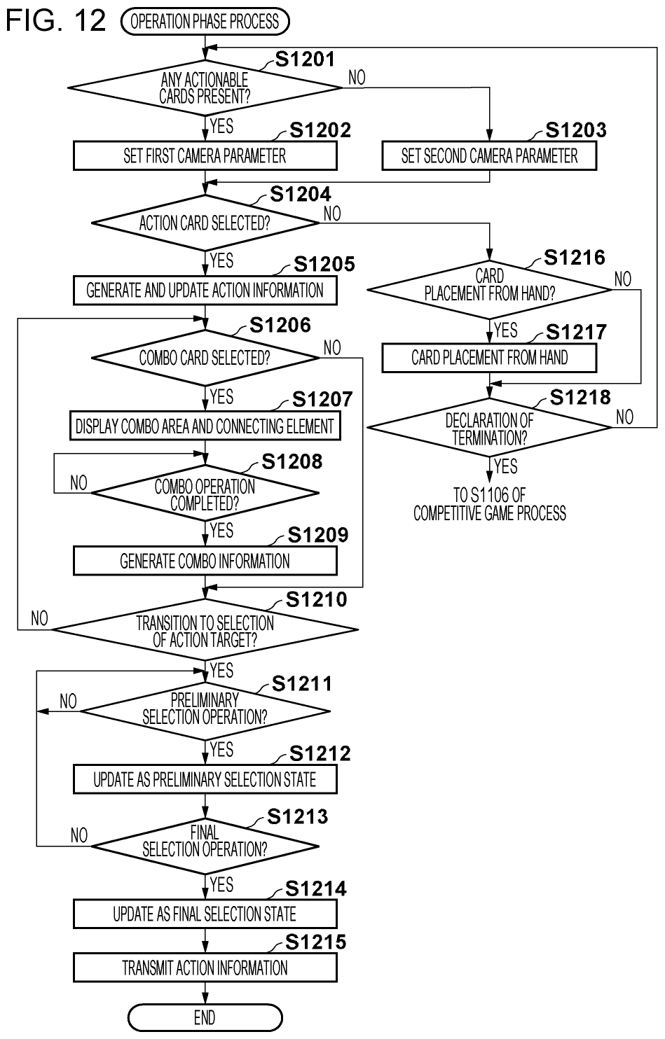

The following will describe details of the operation phase process performed in this step with reference to the flowchart in FIG. 12.

In S1201, the controller 101 determines whether or not any actionable cards (cards in the active state) are present among the cards placed on the field 400 related to the player. In a case where the controller 101 determines that actionable cards are present on the field 400, the process proceeds to S1202, and the controller 101 sets the first camera parameter for rendering the field 400. In a case where the controller 101 determines that actionable cards are not present on the field 400, the process proceeds to S1203, and the controller 101 sets the second camera parameter for rendering the field 400.

In S1204, the controller 101 determines whether or not an operation input related to selection of a card serving as an action executor (action card) has been made for an attack action to be executed. In a case where the controller 101 determines that an operation input related to selection of an action card has been made, the process proceeds to S1205. In a case where the controller 101 determines that an operation input related to selection of an action card has not been made, the process proceeds to S1216.

In S1205, the controller 101 generates action information for the initial state, and updates information regarding the action executor in that action information on the basis of the operation input accepted in S1204.

In S1206, the controller 101 determines whether or not an operation input related to selection of a combo card, which is to be linked to the action card to create a combo, has been made. In a case where the controller 101 determines that an operation input related to selection of a combo card has been made, the process proceeds to S1207. In a case where the controller 101 determines that an operation input related to selection of a combo card has not been made, the process proceeds to S1210.

In S1207, the controller 101 controls the operation of the GPU 104 to display a combo area at the position of the action card and also to display a connecting element connecting the selected combo card and the action card.

In S1208, the controller 101 determines whether or not the combo operation is completed. The combo operation is completed, for example, when a drag-and-drop operation for placing the combo card onto the combo area is performed. In a case where the controller 101 determines that the combo operation is completed, the process proceeds to S1209. In a case where the controller 101 determines that the combo operation is not completed, the process in this step is repeated. In a case where the combo card is deselected or operated so as to be placed outside the combo area, the controller 101 does not determine that the combo operation is completed, and performs control to hide the combo area and the connecting element. Then, the process proceeds to S1210.

In S1209, the controller 101 generates combo information on the basis of the completed combo operation.

In S1210, the controller 101 determines whether or not an operation input that indicates the transition to the selection of a card serving as an action target has been made. As described above, the competitive game according to the present embodiment is configured such that the player can freely select whether or not a combo card is to be linked to the action card to create a combo and how many combo cards are to be linked to create a combo. Thus, in this step, the controller 101 determines whether or not to terminate acceptance of the combo operation, on the basis of the player's operation input that indicates the transition to the selection of a card serving as the action target. In a case where the controller 101 determines that an operation input that indicates the transition to the selection of a card serving as the action target has been made, the process proceeds to S1211. In a case where the controller 101 determines that an operation input that indicates the transition to the selection of a card serving as the action target has not been made, the process returns to S1206.

In S1211, the controller 101 determines whether or not an operation input related to preliminary selection of a card serving as the action target has been made. In a case where the controller 101 determines that an operation input related to preliminary selection of a card serving as the action target has been made, the process proceeds to S1212. In a case where the controller 101 determines that an operation input related to preliminary selection of a card serving as the action target has not been made, the processing in this step is repeated.

In S1212, the controller 101 updates, as a preliminary selection state, the information regarding the action target in the action information. Moreover, the controller 101 controls the operation of the GPU 104 to display a connecting element connecting the action card and the card selected preliminarily as the action target.

In S1213, the controller 101 determines whether or not an operation input related to final selection of a card serving as the action target has been made. In a case where the controller 101 determines that an operation input related to final selection of a card serving as the action target has been made, the process proceeds to S1214. In a case where the controller 101 determines that an operation input related to final selection of a card serving as the action target has not been made, the process returns to S1211.

In S1214, the controller 101 updates, as a final selection state, the information regarding the action target in the action information. Moreover, the controller 101 controls the operation of the GPU 104 to display, in a floating state, the action card and the card selected finally as the action target.

In S1215, the controller 101 transmits information regarding the attack action via the communication I/F 106 to the server 200 and completes this operation phase process. The information regarding the attack action includes not only the action information, but also the combo information in a case where the combo operation was performed.

In contrast, in a case where it is determined in S1204 that an operation input related to the selection of an action card has not been made, the controller 101 determines, in S1216, whether or not an operation input related to the placement of a member card from the hand 404a has been made. In a case where the controller 101 determines that an operation input related to the placement of a member card has been made, the process proceeds to S1217. In a case where the controller 101 determines that an operation input related to the placement of a member card has not been made, the process proceeds to S1218.

In S1217, the controller 101 executes the process for placing the specified member card from the hand 404a onto the corresponding area, on the basis of the operation input accepted in S1216.

In S1218, the controller 101 determines whether or not an operation input related to the declaration of termination of the player's action turn has been made. In a case where the controller 101 determines that an operation input related to the declaration of termination of the player's action turn has been made, this operation phase process is completed, and the process proceeds to S1106 corresponding to the competitive game process. In a case where the controller 101 determines that an operation input related to the declaration of termination of the player's action turn has not been made, the process returns to S1201.

After the operation phase process is completed in this manner, the controller 101 causes the competitive game process to proceed to S1106.

In S1106, the controller 101 executes a resolution phase process in the player's action turn. To execute the resolution phase process, the server controller 201 executes processing related to action resolution on the basis of the action information transmitted in the operation phase process and information regarding an operation input made by the opponent. When the server controller 201 obtains the result of resolving the attack action, the server controller 201 transmits result information regarding the result to the player terminals 100 used by the player and the opponent and connected to the corresponding communication session. Thus, the resolution phase process includes receiving the result information, and generating and displaying the corresponding game screen on the basis of the received result information.

In S1107, the controller 101 determines whether or not the end conditions of the competitive game have been met as a result of the resolution phase process in S1106. That is, the controller 101 determines whether or not the match result of the competitive game has been determined. In a case where the controller 101 determines that the end conditions of the competitive game have been met, the controller 101 displays the match result and completes this competitive game process. In a case where the controller 101 determines that the end conditions of the competitive game have not been met, the process proceeds to S1108.

In S1108, the controller 101 determines whether or not an operation input related to the declaration of termination of the player's action turn has been made. In a case where the controller 101 determines that an operation input related to the declaration of termination of the player's action turn has been made, the process proceeds to S1109. In a case where the controller 101 determines that an operation input related to the declaration of termination of the player's action turn has not been made, the process returns to S1105.

In S1109, the controller 101 terminates the current action turn, the process transitions to the next player's action turn, and the process returns to S1102.

In contrast, in a case where it is determined in S1102 that the current action turn is the opponent's action turn, the controller 101 executes an initialization phase process related to the opponent's action turn in S1110. Moreover, the controller 101 sets the third camera parameter for rendering the field 400.

In S1111, the controller 101 executes a charge phase process related to the opponent's action turn.

In S1112, the controller 101 executes an operation phase process related to the opponent's action turn. In this case, the operation phase process includes displaying a game screen corresponding to an operation input made by the opponent and based on information input during the operation phase process performed in the player terminal 100 of the opponent and transferred to the player terminal 100 of the player via the server 200.

In S1113, the controller 101 determines whether or not execution of an attack action has been instructed in the operation phase process in the opponent's action turn. In a case where the controller 101 determines that the execution of an attack action has been instructed, the process proceeds to S1114. In a case where the controller 101 determines that the execution of an attack action has not been instructed, the process proceeds to S1117.

In S1114, the controller 101 executes a defense action process for accepting an operation input related to a defense action in the resolution phase of the opponent's action turn.

### Defense Action Process

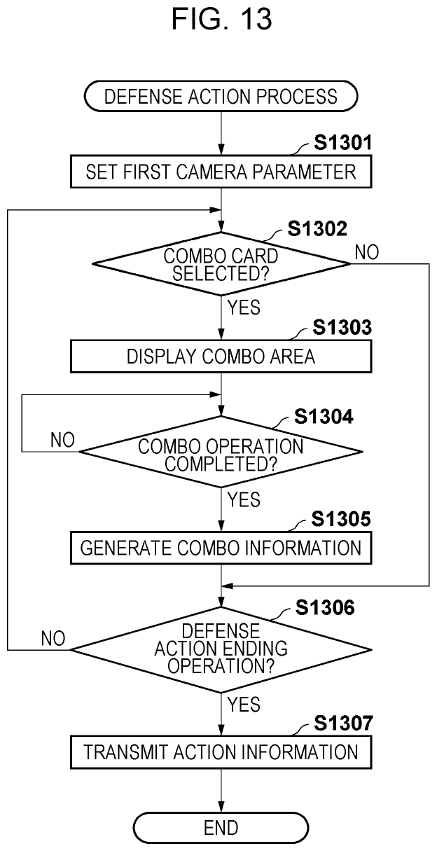

The following will describe details of the defense action process executed in this step with reference to the flowchart in FIG. 13.

In S1301, the controller 101 sets the first camera parameter for rendering the field 400.

In S1302, the controller 101 determines whether or not an operation input related to the selection of a combo card, which is to be linked to a card serving as the action target to create a combo, has been made for an attack action to be executed. In a case where the controller 101 determines that an operation input related to the selection of a combo card has been made, the process proceeds to S1303. In a case where the controller 101 determines that an operation input related to the selection of a combo card has not been made, the process proceeds to S1306.

In S1303, the controller 101 controls the operation of the GPU 104 to display a combo area at the position of the card serving as the action target and also to display a connecting element connecting the card and the selected combo card.

In S1304, the controller 101 determines whether or not the combo operation is completed. In a case where the controller 101 determines that the combo operation is completed, the process proceeds to S1305. In a case where the controller 101 determines that the combo operation is not completed, the processing in this step is repeated. In a case where the combo card is deselected or operated so as to be placed outside the combo area, the controller 101 does not determine that the combo operation is completed, and performs control to hide the combo area and the connecting element. Then, the process proceeds to S1306.

In S1305, the controller 101 generates combo information on the basis of the completed combo operation.

In S1306, the controller 101 determines whether or not an operation input related to ending the defense action has been made. In a case where the controller 101 determines that an operation input related to ending the defense action has been made, the process proceeds to S1307. In a case where the controller 101 determines that an operation input related to ending the defense action has not been made, the process returns to S1302.

In S1307, the controller 101 transmits information regarding the defense action via the communication I/F 106 to the server 200 and completes this defense action process. The information regarding the defense action includes the combo information in a case where the combo operation was performed, and includes information indicating that the combo operation was not performed in a case where the combo operation was not performed.

When the defense action process is completed in this manner, the controller 101 causes the competitive game process to proceed to S1115.

In S1115, the controller 101 executes a resolution phase process in the opponent's action turn. To execute the resolution phase process, the server controller 201 executes processing related to action resolution on the basis of the action information transmitted through the operation phase process executed in the player terminal 100 used by the opponent and information regarding the defense action transmitted through the defense action process. When the server controller 201 obtains the result of resolving the attack action, the server controller 201 transmits result information regarding the result to the player terminals 100 used by the player and the opponent and connected to the corresponding communication session. On the basis of the result information received from the server 200, the controller 101 generates and displays the corresponding game screen.

In S1116, the controller 101 determines whether or not the end conditions of the competitive game have been met as a result of the resolution phase process in S1115. In a case where the controller 101 determines that the end conditions of the competitive game have been met, the controller 101 displays the match result and completes this competitive game process. In a case where the controller 101 determines that the end conditions of the competitive game have not been met, the process proceeds to S1117.

In S1117, the controller 101 determines whether or not the declaration of termination of the opponent's action turn has been made. In a case where the controller 101 determines that the declaration of termination of the opponent's action turn has been made, the process proceeds to S1109. In a case where the controller 101 determines that the declaration of termination of the opponent's action turn has not been made, the process returns to S1113.

As described above, the communication terminal according to the present embodiment can provide highly entertaining play experiences by assisting preferable game progression while making it easy to intuitively grasp operations during the competitive game.

### Modification 1

The above-described embodiments describe a mode in which in a case where an attack action performed on a member card serving as an action target has succeeded, the member card is eliminated from the field 400. However, the implementation of the present invention is not limited to this. For example, a member card may also have a parameter, an endurance value (attribute information), and the member card may be configured such that the endurance value is reduced by a fixed amount or by an amount corresponding to the power difference in a case where an attack action performed on the member card serving as the action target has succeeded. In this mode, the elimination of a member card from the field 400 may be conditioned on the endurance value falling below a predetermined value, such as 0, for example. Therefore, it is sufficient that the game screen also display, for each member card placed on the field 400, information regarding the endurance value of the member card, and the display control to change the endurance value be performed after the display of the presentation effects involving the attack-action-related movement of the card serving as the action executor.

### Modification 2

The above-described embodiments describe a mode in which an operation input to specify an attack action is performed in two steps: an operation input to select an action executor and an operation input to select an action target. However, the implementation of the present invention is not limited to this. The operation input to specify an attack action may be accepted, for example, by performing a drag-and-drop operation to move the card serving as the action executor onto the card serving as the action target, similarly to the combo operation, for example. The operation input to specify an attack action may be configured to be capable of accepting two types of input methods, one involving the movement of the card serving as the action executor and the other not involving such movement.

### Modification 3

The above-described embodiments describe that the combo card 801 in the combo state as illustrated in FIG. 8B is simply placed in the inactive state near the action card 802. However, the implementation of the present invention is not limited to this. For example, after being placed near the action card 802, the display of the combo card 801 may be terminated and the action card 802 may be displayed with emphasis effects instead of the display of the combo card 801. Such emphasis effects can include, for example, display effects such as light particles or debris scattering or burning, or simply a change in brightness or coloration.

### Modification 4

The above-described embodiments describe that a combo card, which is designated to be linked to an action card to create a combo, is described as being placed near the action card in a horizontal state, which is the inactive state, during which operation input is not accepted. However, the implementation of the present invention is not limited to this. A combo card designated to be linked to create a combo may be configured to allow the cancellation of the designation for creating the combo, for example, if it is before the corresponding attack action is executed, namely before the card serving as the action target is specified and the operation phase is completed. The cancellation of the designation for creating the combo may be accepted, for example, in response to the combo card being separated from the action card by a predetermined distance or more through a drag operation. In this case, it is sufficient that the card for which the designation for creating the combo has been canceled be changed to a vertical state (standard orientation) and be returned to the placement position before the designation for the combo.

### Modification 5

The above-described embodiments describe that a combo card can be linked to the action card without using energy. However, the implementation of the present invention is not limited to this. For example, to require a higher level of strategy, the combo operation may also be configured to be accepted on the condition that the energy associated with a combo card is consumed.

### Modification 6

The above-described embodiments describe that the connecting element related to the attack action and the connecting element related to the combo operation are formed in curved line shapes. However, the implementation of the present invention is not limited to this. For example, at least one of these may be formed in a straight line shape.

### Summary of Embodiments

The above-described embodiments disclose at least the following non-transitory computer readable medium storing a program and game apparatus.

(1) A non-transitory computer readable medium storing a program causing a computer to execute a display control process for controlling a display device to display a game screen containing a field, the computer executing an electronic game that progresses by placing game elements on the field, the display control process including:
placing and displaying, among game elements associated with a player, a game element of a first type and a game element of a second type in visually different forms on the field, the game element of the first type and the game element of the second type having different roles in progression of the electronic game.

(2) In the non-transitory computer readable medium according to (1),
each of the game elements is associated with a character,
during execution of the electronic game, in the display control process,
   the character associated with the game element of the second type placed on the field is displayed without any change in the character's appearance, and
   the character associated with the game element of the first type placed on the field is displayed, and its appearance changes in accordance with an action of the character in the electronic game.

(3) In the non-transitory computer readable medium according to (2),
in the display control process, the game element of the first type is displayed, and its appearance changes from a first appearance to a second appearance in accordance with the progression of the electronic game, and
the game element of the first type is in a state that more greatly favors the progression of the competitive game in a case of the first appearance than in a case of the second appearance.

(4) In the non-transitory computer readable medium according to (2) or (3), in the display control process, the game element of the first type is displayed in character form, and the game element of the second type is displayed in card form.

(5) In the non-transitory computer readable medium according to any one of (1) to (4),
the electronic game is a competitive game that progresses between the player and an opponent,
in the display control process, a game element associated with the player and a game element associated with the opponent are placed and displayed on a rectangular-shaped area in the field,
the game element of the first type associated with the player and a game element of the first type associated with the opponent are placed on respective first areas distributed at different ends of the rectangular-shaped area, and
the game element of the second type associated with the player and a game element of the second type associated with the opponent are placed on a second area different from the first area on the rectangular-shaped area.

(6) In the non-transitory computer readable medium according to (5), the second area is distributed in such a manner that the second area is sandwiched between the two first areas on the rectangular-shaped area.

(7) In the non-transitory computer readable medium according to (5) or (6), the two first areas are distributed at diagonal positions on the rectangular-shaped area.

(8) In the non-transitory computer readable medium according to any one of (5) to (7), the two first areas are distributed at positions that are farthest apart on the rectangular-shaped area.

(9) The non-transitory computer readable medium according to any one of (5) to (8), in the display control process, each of the game elements of the second type on the second area is displayed such that it is possible to identify whether the game element of the second type on the second area is associated with the player or with the opponent.

(10) In the non-transitory computer readable medium according to any one of (5) to (9), in the display control process, the game elements of the second type are displayed in an aligned manner on the second area.

(11) In the non-transitory computer readable medium according to (10),
the game elements of the second type are placed on the second area in a standard orientation,
for each of the game elements placed on the field, it is possible to specify an action related to the electronic game, and
in a case where an action is specified for a game element among the game elements of the second type, the orientation of the game element of the second type is changed from the standard orientation to an orientation corresponding to the specified action, and the game element of the second type is displayed in the specified orientation in the display control process.

(12) In the non-transitory computer readable medium according to any one of (5) to (11),
each game element is associated with attribute information, and
in the display control process, for each of the game elements of the first type, the attribute information of the game element is displayed at a position that is near but does not overlap the game element, and
for each of the game elements of the second type, the attribute information of the game element is displayed at a position that overlaps the game element.

(13) In the non-transitory computer readable medium according to (12), the attribute information changes in accordance with the progression of the electronic game.

(14) In the non-transitory computer readable medium according to (13),
the attribute information includes a numerical value, and
in a case where a numerical value of the attribute information of a game element among the game elements of the second type placed on the second area falls below a predetermined value, the game element of the second type is eliminated from the second area in the display control process.

(15) In the non-transitory computer readable medium according to any one of (5) to (14), in the display control process, each of the game elements placed on the field is displayed differently in accordance with whether or not the game element is operable in the progression of the electronic game.

(16) In the non-transitory computer readable medium according to (15),
for each of the game elements placed on the field and associated with the player, it is possible to specify an action related to the electronic game in response to an operation input made to the game element, and
in a case where an operation input is made to the game element placed on the field and associated with the player, an action option that is possible to specify for the game element is displayed in the display control process.

(17) In the non-transitory computer readable medium according to (16),
the action option that is possible to specify includes an option for specifying, as a target of the action, one of the game elements placed on the field and associated with the opponent, and
in the display control process, a presentation effect is displayed that moves, in response to activation of the action, the game element for which the action is specified to a position of the game element serving as the target of the action and thereafter returns the game element for which the action is specified to a position at which the game element for which the action is specified was placed before the movement.

(18) In the non-transitory computer readable medium according to any one of (1) to (17), on a condition that an operation input has been made to a game element placed on the field, detailed information regarding the game element is displayed in the display control process.

(19) In the non-transitory computer readable medium according to any one of (1) to (18),
the game screen contains a preparation area that displays one or more game elements of the second type, which are not yet placed on the field, and
in a case where a placement operation input is made to a game element of the second type placed on the preparation area, the game element is displayed moving from the preparation area onto the field in the display control process.

(20) In the non-transitory computer readable medium according to any one of (1) to (19),
the field has an appearance representing a ground, and
in the display control process, the field is displayed, and its appearance changes in accordance with the progression of the electronic game.

(21) A game apparatus that executes an electronic game that progresses by placing game elements on a field, including
a display controller that controls a display device to display a game screen containing the field,
the display controller places and displays, among game elements associated with a player, a game element of a first type and a game element of a second type in visually different forms on the field, the game element of the first type and the game element of the second type having different roles in progression of the electronic game.

### OTHER EMBODIMENTS

The invention is not limited to the above-described embodiments, and various variations and changes are possible within the scope of the gist of the invention.

What is claimed is:

1. A non-transitory computer readable medium storing a program causing a computer to execute a display control process for controlling a display device to display a game screen containing a field, the computer executing an electronic game that progresses by placing game elements on the field, the display control process comprising:
placing and displaying, among game elements associated with a player, a game element of a first type and a game element of a second type in visually different forms on the field, the game element of the first type and the game element of the second type having different roles in progression of the electronic game.

2. The non-transitory computer readable medium according to claim 1, wherein
each of the game elements is associated with a character,
during execution of the electronic game, in the display control process,
the character associated with the game element of the second type placed on the field is displayed without any change in the character's appearance, and
the character associated with the game element of the first type placed on the field is displayed, and its appearance changes in accordance with an action of the character in the electronic game.

3. The non-transitory computer readable medium according to claim 2, wherein
in the display control process, the game element of the first type is displayed, and its appearance changes from a first appearance to a second appearance in accordance with the progression of the electronic game, and
the game element of the first type is in a state that more greatly favors the progression of the competitive game in a case of the first appearance than in a case of the second appearance.

4. The non-transitory computer readable medium according to claim 2, wherein in the display control process, the game element of the first type is displayed in character form, and the game element of the second type is displayed in card form.

5. The non-transitory computer readable medium according to claim 1, wherein
the electronic game is a competitive game that progresses between the player and an opponent,
in the display control process, a game element associated with the player and a game element associated with the opponent are placed and displayed on a rectangular-shaped area in the field,
the game element of the first type associated with the player and a game element of the first type associated with the opponent are placed on respective first areas distributed at different ends of the rectangular-shaped area, and
the game element of the second type associated with the player and a game element of the second type associated with the opponent are placed on a second area different from the first area on the rectangular-shaped area.

6. The non-transitory computer readable medium according to claim 5, wherein the second area is distributed in such a manner that the second area is sandwiched between the two first areas on the rectangular-shaped area.

7. The non-transitory computer readable medium according to claim 5, wherein the two first areas are distributed at diagonal positions on the rectangular-shaped area.

8. The non-transitory computer readable medium according to claim 5, wherein the two first areas are distributed at positions that are farthest apart on the rectangular-shaped area.

9. The non-transitory computer readable medium according to claim 5, wherein in the display control process, each of the game elements of the second type on the second area is displayed such that it is possible to identify whether the game element of the second type on the second area is associated with the player or with the opponent.

10. The non-transitory computer readable medium according to claim 5, wherein in the display control process, the game elements of the second type are displayed in an aligned manner on the second area.

11. The non-transitory computer readable medium according to claim 10, wherein
the game elements of the second type are placed on the second area in a standard orientation,
for each of the game elements placed on the field, it is possible to specify an action related to the electronic game, and
in a case where an action is specified for a game element among the game elements of the second type, the orientation of the game element of the second type is changed from the standard orientation to an orientation corresponding to the specified action, and the game element of the second type is displayed in the specified orientation in the display control process.

12. The non-transitory computer readable medium according to claim 5, wherein
each game element is associated with attribute information, and
in the display control process, for each of the game elements of the first type, the attribute information of the game element is displayed at a position that is near but does not overlap the game element, and
for each of the game elements of the second type, the attribute information of the game element is displayed at a position that overlaps the game element.

13. The non-transitory computer readable medium according to claim 12, wherein the attribute information changes in accordance with the progression of the electronic game.

14. The non-transitory computer readable medium according to claim 13, wherein
the attribute information includes a numerical value, and
in a case where a numerical value of the attribute information of a game element among the game elements of the second type placed on the second area falls below a predetermined value, the game element of the second type is eliminated from the second area in the display control process.

15. The non-transitory computer readable medium according to claim 5, wherein in the display control process, each of the game elements placed on the field is displayed differently in accordance with whether or not the game element is operable in the progression of the electronic game.

16. The non-transitory computer readable medium according to claim 15, wherein
for each of the game elements placed on the field and associated with the player, it is possible to specify an action related to the electronic game in response to an operation input made to the game element, and
in a case where an operation input is made to the game element placed on the field and associated with the player, an action option that is possible to specify for the game element is displayed in the display control process.

17. The non-transitory computer readable medium according to claim 16, wherein
the action option that is possible to specify includes an option for specifying, as a target of the action, one of the game elements placed on the field and associated with the opponent, and
in the display control process, a presentation effect is displayed that moves, in response to activation of the action, the game element for which the action is specified to a position of the game element serving as the target of the action and thereafter returns the game element for which the action is specified to a position at which the game element for which the action is specified was placed before the movement.

18. The non-transitory computer readable medium according to claim 1, wherein on a condition that an operation input has been made to a game element placed on the field, detailed information regarding the game element is displayed in the display control process.

19. The non-transitory computer readable medium according to claim 1, wherein
the game screen contains a preparation area that displays one or more game elements of the second type, which are not yet placed on the field, and
in a case where a placement operation input is made to a game element of the second type placed on the preparation area, the game element is displayed moving from the preparation area onto the field in the display control process.

20. The non-transitory computer readable medium according to claim 1, wherein
the field has an appearance representing a ground, and
in the display control process, the field is displayed and its appearance changes in accordance with the progression of the electronic game.

21. A game apparatus that executes an electronic game that progresses by placing game elements on a field, comprising:
a display controller that controls a display device to display a game screen containing the field, wherein
the display controller places and displays, among game elements associated with a player, a game element of a first type and a game element of a second type in visually different forms on the field, the game element of the first type and the game element of the second type having different roles in progression of the electronic game.
